(19) United States
(12) Patent Application Publication
(10) Pub. No.: US 2025/0365593 A1
(43) Pub. Date: Nov. 27, 2025

(54) CELL MEASUREMENT DATA AND EVALUATING PERFORMANCE OF A CELL IN A COMMUNICATION NETWORK

(71) Applicant: Telefonaktiebolaget LM Ericsson (publ), Stockholm (SE)

(72) Inventors: Yu JIA, Beijing (CN); Chin Lam ENG, Tokyo (JP)

(21) Appl. No.: 18/872,925

(22) PCT Filed: Oct. 21, 2022
(86) PCT No.: PCT/SE2022/050957

§ 371 Date: Dec. 9, 2024

(30) Foreign Application Priority Data
Jun. 17, 2022 (WO) PCT/CN2022/099509

(51) Int. Cl. H04W 24/10; H04B 17/318; H04W 64/00

(52) U.S. Cl. CPC H04W 24/10; H04B 17/318; H04W 64/00

(57) ABSTRACT

Preparing cell measurement data for use with a machine learning, model. The method includes receiving a plurality of measurement reports for a first cell in a communication network; obtaining cell information for the first cell, wherein the cell information includes a geolocation of an antenna of a base station that provides the first cell and an azimuth angle indicating a direction of the antenna; for each measurement report, forming a converted measurement report by using the geolocation of the antenna and azimuth angle to convert the geolocation of the measurement report to a polar coordinate system; assigning each converted measurement report to a data bin, each data bin corresponds corresponding to a respective annular sector of a coverage area of the first cell; generating cell measurement data for the first cell.

### TECHNICAL FIELD

This disclosure relates to methods and apparatus relating to preparation of cell measurement data for use with a machine learning (ML) model, and to methods and apparatus relating to training a ML model for evaluating a performance of a cell in a communication network.

### BACKGROUND

In operation or performance management of a communication network, carrying out a radio frequency (RF) performance analysis of a cell is one of the first steps to perform, and involves a significant portion of the cost and efforts. In this step, engineers need to analyse the measurement records (MRs), which have associated geolocation information (and which are also referred to herein as “geolocated MRs”) to find if there is any antenna orientation issue, coverage distance issue and/or interference issue (also called a quality issue). These types of issues are often responsible for significant radio network performance degradation if they are not detected and fixed early. Hence, it is important to perform a radio frequency performance analysis of cells in an in-depth, holistic and efficient way.

If there is any antenna orientation issue, the coverage of the cell could be in the wrong direction compared to the planned one, such as in another cell's coverage area (which is known as an antenna swapping issue), in the reverse direction area (which is known as a reverse coverage issue) or in any clockwise/counter-clockwise rotation area, etc., which could be caused by erroneous installation or reflection by obstacles, etc. The latter issues are referred to as antenna orientation issues, which could be determined by the distribution of a received signal strength measurements in MRs obtained at different locations. A suitable signal strength measurement can be reference signal received power (RSRP).

If there is any coverage distance issue, it could be overshooting issues, which means the coverage is much larger than intended and it will interfere with the coverage of other cells or suffer interference from other cells. Alternatively, it could be ‘limited coverage’ issues, which means that the coverage is much smaller than intended, which will impact the continuity of mobile connections or reduce the cell's capacity. These coverage distance issues could also be detected by the distribution of signal strength measurements (e.g. RSRP) in MRs obtained at different locations.

A downlink interference issue (downlink quality issue) means the desired radio signal is interfered with either by the surrounding cells or other out-of-system interference, which will degrade the service quality, and result in effects such as low downloading throughput or bad call quality. The cell interference issue can be identified by the distribution of received signal quality measurements in geolocated MRs. A suitable signal quality measurement can be reference signal received quality (RSRQ).

The geolocated MRs could be from a cell's minimum drive test (MDT) radio feature logs, active drive test log data from user equipments (UEs), third party over-the-top (OTT) log data (which is data provided by third parties and that it is directly collected from applications installed in the UEs, whose cell identifier (e.g. cellid) was already mapped by the third party) or their combination. Typically the MRs include the cell identity, the geolocation of the MR, signal strength measurement (e.g. RSRP) and signal quality measurement (e.g. RSRQ).

Currently, drive testing is the most common solution used by operators to perform a cell RF performance analysis. These methods obtain the RSRP and RSRQ measurements together with geolocation information by means of data collection equipment and the measurements/information are analysed to determine whether the cell has any type of RF performance issue.

When minimum drive test (MDT) records data or other third party OTT data (with cellid mapped) are introduced, engineers can also use this kind of network ‘side collected data’ to analyse the cell RF performance. However, manually analysing cell performance is time consuming and does not scale efficiently in a large-scale network. In addition, as the above processes typically rely on engineers' expertise, it is difficult to guarantee the accuracy of the cell RF performance analysis.

These challenges have led to several automated approaches being proposed, such as in CN 101753228A and CN 108375363A. However, these and other methods focus on the antenna azimuth estimation or state detection, they can only detect the cell orientation issues and cannot give a complete cell performance analysis (which implies analysing the orientation, coverage and quality at the same time). Even for the cell orientation estimation or detection, they do not use the real distributed data from the real network, but instead use some data augmentation means to rotate the samples to create angle deviation. This augmentation data is too simple to reflect the complicated field situations, because in the real world the measurement records' distribution could be very different, and the accuracy of a model just trained by augmentation data will degrade significantly.

Therefore there is a need for improvements to cell measurement data, in particular to improvements in the amount and quality of cell measurement data used for cell performance analysis, and improvements in cell performance analysis itself.

### SUMMARY

As noted above, cell RF performance analysis is important for a communication network. Cell RF performance can be expressed in term of any of: antenna orientation, coverage distance and quality, and can be determined from an analysis of geolocated MR data. This data can be from MDT collection, field drive tests or third party OTT data (with mapped cellids). Due to the large volume and the data complexity, it is a time-consuming task for network engineers to manually investigate and analyse the data.

Therefore, the techniques described herein provide for the preparation of cell measurement data for use with a machine learning (ML) model, training a ML model using cell measurement data to evaluate a performance of a cell in a communication network, and evaluating the performance of a cell in a communication network using a trained ML model. Such techniques both increase the work efficiency and result accuracy in evaluating the performance of a cell in a communication network.

According to a first aspect, there is provided a computer-implemented method of preparing cell measurement data for use with a machine learning, ML, model. The method comprises (a) receiving a plurality of measurement reports for a first cell in a communication network, each measurement report comprising a measurement of signal quality of signals in the first cell by a device, a measurement of signal strength in the first cell by the device, and a geolocation measurement indicating a geolocation of the device when the signal quality measurement and signal strength measurement were obtained; (b) obtaining cell information for the first cell, wherein the cell information comprises a geolocation of an antenna of a base station that provides the first cell and an azimuth angle indicating a direction of the antenna; (c) for each measurement report, forming a converted measurement report by using the geolocation of the antenna and azimuth angle to convert the geolocation of the measurement report to a polar coordinate system with the antenna as an origin of the polar coordinate system and the direction of the antenna as a polar angle reference direction; (d) assigning each converted measurement report to a data bin according to polar coordinates of the converted measurement report, wherein each data bin corresponds to a respective annular sector of a coverage area of the first cell; (e) generating cell measurement data for the first cell, the cell measurement data comprising a respective signal quality value and signal strength value for each data bin.

According to a second aspect, there is provided a computer-implemented method of training a machine learning, ML, model to evaluate a performance of a cell in a communication network. The method comprises receiving cell measurement data for a plurality of cells in the communication network; training an autoencoder to compress the cell measurement data while minimising a reconstruction error; identifying at least one cell that has poor performance based on the reconstruction error for the cell measurement data for said cell relative to a reconstruction error threshold value; forming a training data set that comprises the cell measurement data for the at least one cell identified to have poor performance, and cell measurement data for one or more other cells in the plurality of cells; applying the cell measurement data in the training data set to the trained autoencoder and a clustering layer, wherein the clustering layer receives an encoded representation of the cell measurement data from an encoding stage of the autoencoder, and wherein the clustering layer clusters the encoded representations of the cell measurement data to minimise a clustering loss; labelling each cluster according to a performance of the cells in the cluster and adding the labels to the relevant cell measurement data in the training data set to form a labelled training data set; training a ML model using the labelled training data set, wherein the ML model is trained to evaluate a performance of a cell based on input cell measurement data.

According to a third aspect, there is provided an apparatus for preparing cell measurement data for use with a machine learning, ML, model. The apparatus is configured to: (a) receive a plurality of measurement reports for a first cell in a communication network, each measurement report comprising a measurement of signal quality of signals in the first cell by a device, a measurement of signal strength in the first cell by the device, and a geolocation measurement indicating a geolocation of the device when the signal quality measurement and signal strength measurement were obtained; (b) obtain cell information for the first cell, wherein the cell information comprises a geolocation of an antenna of a base station that provides the first cell and an azimuth angle indicating a direction of the antenna; (c) for each measurement report, form a converted measurement report by using the geolocation of the antenna and azimuth angle to convert the geolocation of the measurement report to a polar coordinate system with the antenna as an origin of the polar coordinate system and the direction of the antenna as a polar angle reference direction; (d) assign each converted measurement report to a data bin according to polar coordinates of the converted measurement report, wherein each data bin corresponds to a respective annular sector of a coverage area of the first cell; (e) generate cell measurement data for the first cell, the cell measurement data comprising a respective signal quality value and signal strength value for each data bin.

According to a fourth aspect, there is provided an apparatus for training a machine learning, ML, model to evaluate a performance of a cell in a communication network. The apparatus configured to: receive cell measurement data for a plurality of cells in the communication network; train an autoencoder to compress the cell measurement data while minimising a reconstruction error; identify at least one cell that has poor performance based on the reconstruction error for the cell measurement data for said cell relative to a reconstruction error threshold value; form a training data set that comprises the cell measurement data for the at least one cell identified to have poor performance, and cell measurement data for one or more other cells in the plurality of cells; apply the cell measurement data in the training data set to the trained autoencoder and a clustering layer, wherein the clustering layer receives an encoded representation of the cell measurement data from an encoding stage of the autoencoder, and wherein the clustering layer clusters the encoded representations of the cell measurement data to minimise a clustering loss; label each cluster according to a performance of the cells in the cluster and adding the labels to the relevant cell measurement data in the training data set to form a labelled training data set; train a ML model using the labelled training data set, wherein the ML model is trained to evaluate a performance of a cell based on input cell measurement data.

According to a fifth aspect, there is provided an apparatus for preparing cell measurement data for use with a machine learning, ML, model. The apparatus comprises a processor and a memory, said memory containing instructions executable by said processor whereby said apparatus is operative to: (a) receive a plurality of measurement reports for a first cell in a communication network, each measurement report comprising a measurement of signal quality of signals in the first cell by a device, a measurement of signal strength in the first cell by the device, and a geolocation measurement indicating a geolocation of the device when the signal quality measurement and signal strength measurement were obtained; (b) obtain cell information for the first cell, wherein the cell information comprises a geolocation of an antenna of a base station that provides the first cell and an azimuth angle indicating a direction of the antenna; (c) for each measurement report, form a converted measurement report by using the geolocation of the antenna and azimuth angle to convert the geolocation of the measurement report to a polar coordinate system with the antenna as an origin of the polar coordinate system and the direction of the antenna as a polar angle reference direction; (d) assign each converted measurement report to a data bin according to polar coordinates of the converted measurement report, wherein each data bin corresponds to a respective annular sector of a coverage area of the first cell; (e) generate cell measurement data for the first cell, the cell measurement data comprising a respective signal quality value and signal strength value for each data bin.

According to a sixth aspect, there is provided an apparatus for training a machine learning, ML, model to evaluate a performance of a cell in a communication network. The apparatus comprises a processor and a memory, said memory containing instructions executable by said processor whereby said apparatus is operative to: receive cell measurement data for a plurality of cells in the communication network; train an autoencoder to compress the cell measurement data while minimising a reconstruction error; identify at least one cell that has poor performance based on the reconstruction error for the cell measurement data for said cell relative to a reconstruction error threshold value; form a training data set that comprises the cell measurement data for the at least one cell identified to have poor performance, and cell measurement data for one or more other cells in the plurality of cells; apply the cell measurement data in the training data set to the trained autoencoder and a clustering layer, wherein the clustering layer receives an encoded representation of the cell measurement data from an encoding stage of the autoencoder, and wherein the clustering layer clusters the encoded representations of the cell measurement data to minimise a clustering loss; label each cluster according to a performance of the cells in the cluster and adding the labels to the relevant cell measurement data in the training data set to form a labelled training data set; train a ML model using the labelled training data set, wherein the ML model is trained to evaluate a performance of a cell based on input cell measurement data.

According to a seventh aspect, there is provided a computer program product comprising a computer readable medium having computer readable code embodied therein, the computer readable code being configured such that, on execution by a suitable computer or processor, the computer or processor is caused to perform the method according to the first aspect, the second aspect, or any embodiments thereof.

### BRIEF DESCRIPTION OF THE DRAWINGS

Some of the embodiments contemplated herein will now be described more fully with reference to the accompanying drawings, in which:

FIG. 1 is a flow diagram outlining aspects of the techniques described herein for preparing cell measurement data, training a ML model and using a ML model to evaluate the performance of a communication network;

FIG. 2 is a simplified block diagram of an apparatus according to some embodiments;

FIG. 3 is a block diagram illustrating a virtualization environment in which functions implemented by some embodiments may be virtualized;

FIG. 4 is a block diagram outlining a containerised implementation of the techniques described herein;

FIG. 5 illustrates the transformation and rotation of a set of MRs;

FIG. 6 illustrates cell antenna and coverage radius calculation;

FIG. 7 illustrates the calculation of the cell observation radius, r_{obs}, for a cell i;

FIG. 8 illustrates the calculation of the observation radius from MRs in three scenarios;

FIG. 9 illustrates a 12*12 bin arrangement for cellᵢ;

FIG. 10 is a visualisation of the binning in a data sample for RSRP, RSRQ and Density;

FIG. 11 shows an exemplary data array with 3 channels;

FIG. 12 illustrates the allocation and combination of data into a three channel input array;

FIG. 13 illustrates the effect of interpolation of RSRP values;

FIG. 14 illustrates an autoencoder architecture for anomaly detection according to some embodiments;

FIG. 15 illustrates the output of autoencoder and selection of anomalous samples;

FIG. 16 illustrates a model training process according to some embodiments;

FIG. 17 illustrates an exemplary deep learning convolution neural network with a skip connect architecture;

FIG. 18 is a flow chart illustrating a method in accordance with some embodiments; and

FIG. 19 is a flow chart illustrating another method in accordance with some embodiments.

### DETAILED DESCRIPTION

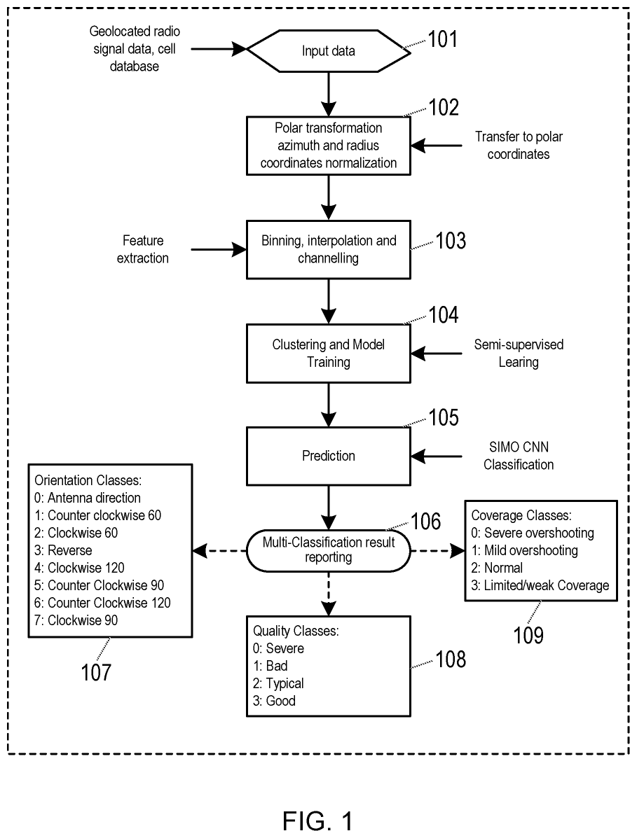

A flow diagram that outlines aspects of the techniques described herein including the preparation of cell measurement data, training a ML model, and using a ML model to evaluate the performance of a communication network is shown in FIG. 1.

As used herein, the word “cell” refers to the coverage of control signals carrying specific cell identities being transmitted by an antenna, e.g. as defined in the Third Generation Partnership Project (3GPP) 4^{th} Generation (4G) and 5^{th} Generation (5G) standards, which are also known as Long Term Evolution (LTE) and New Radio (NR) respectively. A cell will be associated with a particular antenna, with the antenna having respective characteristics including an azimuth direction, a tilt angle, and a height above the ground. For the purposes of this disclosure in assessing the performance of a cell (or the antenna providing the cell), where a cell is provided by multiple antennas that are at respective different geolocations (i.e. the antennas each transmit control signals for the same cell identity), each of those antennas is considered to control it's own cell.

At step 101 input data is received that is in the form of measurement reports (MRs) for one or more cells in a communication network. The measurement reports comprise measurements of signal quality and signal strength, and a geolocation at which the measurements were obtained. The MRs may be MDTs, UE drive test logs and/or OTT data. Information about the cell(s) is also obtained at step 101, including information indicating a geolocation of an antenna that provides the cell and an azimuth angle indicating the direction of the antenna.

In step 102 the input data is transformed to polar coordinates, with coordinate normalisation. That is, the geolocations of the MRs are transformed to polar coordinates with the cell antenna as the origin of the polar coordinate system. This conversion to polar coordinates improves the efficiency of cell orientation and coverage distance issue detection. Normalisation of each MR's θ axis by the orientation rotation simplifies the model's complexity and increases the prediction accuracy.

In step 103, the MRs are spatially binned according to their polar coordinates for all three radio attributes and optionally interpolated for signal strength to create a multi-channel data array. This data array—also more generally referred to as “cell measurement data” or a “data sample” herein—forms the input to the model training and subsequent performance predictions. A respective data array/cell measurement data is formed for each cell for which MRs are available. Encoding polar coordinates to an array location unifies the data arrays shape for multiple cells and simplifies the input information for training the ML model. In some embodiments, an optimum observation cell radius is introduced which considers both the serving cell and surrounding cell geographical distributions, and the serving cell's antenna configuration. The combination of signal strength (e.g. RSRP), signal quality (e.g. RSRQ) and sample density information in the same geolocation point to different channels, which also helps (in subsequent steps) the machine learning model to learn input characteristics efficiently. In some embodiments, the spatial binning uses a non-uniform (variable) interval to provide dynamic area segmentation to address varying densities of MR sample distribution. In some embodiments, interpolation of values of signal strength (e.g. RSRP) in the spatial bins in the radial direction can be used to overcome the sparse MR distribution samples, improving the cell measurement data and enabling the trained ML model to be more robust.

For the clustering and model training in step 104, semi-supervised learning methods are used to annotate the training data set. Semi-supervised model training is performed with real network data to integrate engineer experience and enable the recognition of complicated patterns in the real world. In some embodiments, the ML model is a skip-connect deep learning convolution neural network (CNN), with a single input branch and three output branches, respectively corresponding to orientation, coverage and quality.

In step 105 the trained model is used to predict the performance of a cell based on cell measurement data, and provides a multi-classified prediction result for the cell (step 106), in terms of an orientation class (107), a quality class (108) and a coverage class (109). By using a single input multiple output (SIMO) architecture, the insufficient sample issue is solved when there are too many classes in the classifier, but at the same time enforces the model's capability to extract common performance characteristics.

The various different aspects outlined above can provide a number of different advantages.

Transformation of coordinates to polar coordinates—Traditionally, measurement records are in a cartesian coordinate (rectangular coordinates) system, e.g. a latitude and a longitude. Conventional techniques use the Cartesian coordinates to perform binning or other processing of the data. However, since the cell performance is to be considered in terms of the cell orientation (e.g. an actual deviation of coverage orientation) or coverage distance (e.g. an actual coverage area radius), the use of polar coordinates is beneficial. This is because the coverage orientation deviation issue is analysed using the distribution of MRs location relative to the serving cell's design azimuth, and the coverage area radius issue is analysed using the distribution of the MRs distance relative to serving cell. In the techniques described herein, by setting the serving cell's location as the pole and the serving cell's antenna azimuth as the angular reference, the MRs distance to the serving cell and relative angle to the serving cell's antenna design azimuth are transferred to the MRs' radius and angle coordinates respectively. In addition, in polar coordinates, it is straightforward to perform interpolation in the radial direction, if this is desired. Polar coordinates also makes it easier to describe the location of MR points that could be anywhere in the 360° around the serving cell. One serving cell and its surrounding measurement records in their specific polar coordinates (with further processing) can be used as a training sample.

Generalisation of cell radio information features relative to the antenna azimuth—This generalisation enables the resulting trained ML model to be system and network agnostic.

The generalisation can include one or more of several types of normalisation: cell radius normalisation, polar angular normalisation, non-uniform (variable) interval spatial binning, and a normalised array shape.

Cell radius normalisation: In the actual network, each cell has a different design-intended coverage radius, which is decided by the cell distribution density (considering its surrounding cells) and its antenna configuration (e.g. height, and antenna vertical beam electrical or mechanical angle downtilt). When performing the binning, both factors (radio propagation radius and cell distribution density) can be considered and an observation radius can be calculated, which is always larger than the planned radius. MRs within this observation radius can be considered. With this optimum observation radius, it is possible to analyse if there are any MRs representing ‘overshooting’, indicating the cell has a much larger distance (radius) than planned, and at the same time, make sure the observation radius is not too large, which will degrade the resolution ratio of the coverage details. Therefore, each training data sample (i.e. relating to a particular cell) will have a specific observation radius, which can also be used to decide the binning size of this sample.

Polar angular normalisation: When processing the MR coordinates, each sample's polar angle by using the cell antenna's direction as the reference direction. This means that, no matter what the designed antenna azimuth is, the serving cell's azimuth is always 0° in the polar coordinates. Since the serving cell antenna coordinates are set as the pole, this makes the serving cell the centre of the polar coordinate system. With the serving cell antenna azimuth direction as the polar reference direction, this will unify all samples' polar angle coordinates and make it easier to train the model to detect an antenna rotation issue.

Non-uniform (variable) interval spatial binning: This feature provides for dynamic area segmentation (e.g. larger bins at distances further from the antenna position) to address the varying spatial densities of MRs for that cell. In this way, the method can capture the general MDT bins' distribution character, without losing the distribution details for those bins near to the antenna. The polar coordinates transformation facilitates the usage of this technique, by which not only the arc length increases in the radial direction, but it also makes it possible to use an increasing segment distance for the polar bin. This technique also means that for different cells with different cell radiuses, the segment distance at the same bin position is also different.

Normalized array shape: For each data sample, which consists of the serving cell's geolocated measurement records, with geolocations expressed in polar coordinates (and the serving cell's location as the pole and the antenna direction as the polar angle reference), the MRs are binned into a 3D array (a 3D matrix). In some embodiments, the 3D array can have dimensions corresponding to (t, r, c), in which t represents the bin's azimuth, r represents the radius axes, and c represents the number of channels (types of information), as explained in the next paragraph).

Multiple channel data preparation—In the third dimension of the array (the types of information), there are three positions which locate the three kinds of statistics values of MRs that are geolocated in this bin. These statistics values are those MRs' signal strength (e.g. RSRP), signal quality (e.g. RSRQ), and volume (transferred to density after normalisation) respectively, which can also be understood as the three types of bin characters that are located in three channels. This multiple channel data preparation helps the model to perform a cell RF performance simultaneous analysis. Since the three kinds of information actually have their interrelation connections and a 3D spatial matrix is an input to the deep learning convolutional neural network (CNN), the CNN can capture this type of spatial correlation. This is similar to the use of CNNs in capturing features in multi-channel red-green-blue (RGB) images. In RGB images, each colour channel has correlations and yet differences with the other two, which is similar to a MR bin's three characteristics, which have both correlations and differences.

RSRP Interpolation—Considering the sparse geographic distribution of geolocated measurement records, data interpolation can be performed, particularly for the signal strength (e.g. RSRP) channel based on RF propagation theory in the radial direction, which increases the data density in one sample and helps the model to perform pattern recognition. As a result of the polar coordinates mentioned previously, the signal strength interpolation could be performed easily in the radial direction. Likewise, interpolation can be performed in the lateral direction (i.e. in bins that are the same radius from the antenna).

Geo-location information embedded in the matrix position—As mentioned above with respect to the normalised array shape, a bins' geolocation information (which is the azimuth and radius axes) is embedded in the array's (t, r) positions, which simplify the input information significantly. This is one type of feature extraction technique that compresses the geolocation information to the matrix's position. Without this kind of processing, a bin's geolocated information has to be described explicitly in some kind of measure, and then the input will be much more complex and the generalisation of the existing machine learning model will be much more difficult.

Semi-supervised model training with real network data—To create labels for each sample is a challenge for real network data, considering each sample has different kinds of radio signal profiles. Therefore, initially labelling can be performed by a clustering algorithm. Domain expertise can be used to perform an audit of the initial labels. After the initial training with the audit label, incorrect classification samples can be checked again by domain experts to correct the labels, and filter out some out of the class samples, which increases the label accuracy and helps the model to learn the pattern. Using actual network data ensures that comprehensive patterns are considered in creating the dataset.

Skip-connect deep learning neural network—The ML model is a mutual skip-connect deep learning conventional neural network, which is popular in the image recognition field for tackling the vanishing gradient problem (which occurs when gradient-based learning methods and backpropagation are used to train artificial neural networks). The use of such a neural network in evaluation of the performance of a cell provides increased validation accuracy compared to ML models used in existing techniques. The use of skip-connections in deep learning neural networks is described in “Deep residual learning for image recognition” by He, K., Zhang, X., Ren, S., & Sun, J., in Proceedings of the IEEE conference on computer vision and pattern recognition (pp. 770-778) 2016.

Single input multiple output (SIMO) architecture—The ML model has a single input branch, which is a data array as described above (e.g. a 12×12×3 data array), where the three channels include three types of related information. The model has multiple output branches, which in the example of FIG. 1 is three. Each output branch can have a plurality of output values/classes, which in the example shown in FIG. 1 is 8, 4 and 4 respectively (i.e. the predicted categories of orientation 107, distance 108 and quality 109 respectively, the three aspects of the cell RF coverage analysis). In this SIMO architecture, the common layer helps the ML model to extract the common features and the different branches extract the particular features per issue typology, which increases the classification accuracy. Through the use of the SIMO architecture and the 8, 4 and 4 output values, with one input there are 128(8*4*4) possible outputs after combination. It is not possible to perform model training with a single input single output (SISO) architecture if the three branches (8, 4, 4) labels are ‘flattened’ to 128 labels when most of the categories do not have enough samples. In addition, using one trained model to solve three related problems simplifies the usage of the model when incorporating it into the application.

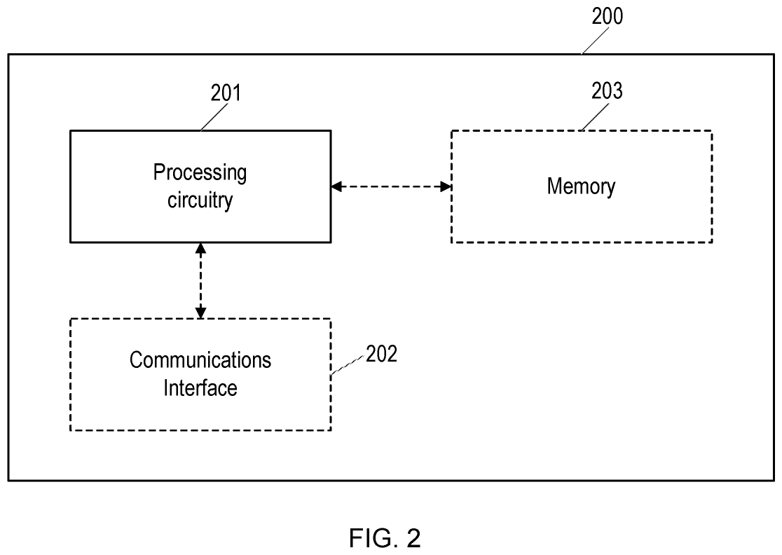

FIG. 2 is a simplified block diagram of an apparatus 200 according to some embodiments that can be used to implement one or more of the techniques described herein. The apparatus 200 can be a network node in a core network of a communication network, or it can be a base station, computer, server or any other suitable type of computing device, that may be part of, or external to, the communication network from which the MRs are obtained.

The apparatus 200 comprises processing circuitry (or logic) 201. It will be appreciated that the apparatus 200 may comprise one or more virtual machines running different software and/or processes. The apparatus 200 may therefore comprise, or be implemented in or as one or more servers, switches and/or storage devices and/or may comprise cloud computing infrastructure that runs the software and/or processes.

The processing circuitry 201 controls the operation of the apparatus 200 to implement one or more of the methods of preparing cell measurement data for use with a ML model, and training a ML model to evaluate performance of a cell in a communication network as described herein. The processing circuitry 201 can comprise one or more processors, processing units, multi-core processors or modules that are configured or programmed to control the apparatus 200 in the manner described herein. In particular implementations, the processing circuitry 201 can comprise a plurality of software and/or hardware modules that are each configured to perform, or are for performing, individual or multiple steps of the method described herein in relation to the apparatus 200.

The apparatus 200 may also comprise a communications interface 202. The communications interface 202 is for use in enabling communications with other nodes, apparatus, computers, servers, etc. For example, the communications interface 202 can be configured to transmit to and/or receive from other apparatus or nodes requests, acknowledgements, information, data, signals, or similar. The communications interface 202 can use any suitable communication technology.

The processing circuitry 201 may be configured to control the communications interface 202 to transmit to and/or receive from other apparatus or nodes, etc. requests, acknowledgements, information, data, signals, or similar, according to the methods described herein. In some embodiments, the MRs for one or more cells can be received by the apparatus 200 via the communications interface 202.

The apparatus 200 may comprise a memory 203. In some embodiments, the memory 203 can be configured to store program code that can be executed by the processing circuitry 201 to perform the method described herein in relation to the apparatus 200. Alternatively or in addition, the memory 203 can be configured to store any requests, acknowledgements, information, data, signals, or similar that are described herein. The processing circuitry 201 may be configured to control the memory 203 to store such information therein. In some embodiments, the memory 203 can store the MRs for one or more cells ready for processing according to the techniques described herein. In some embodiments, the memory 203 can store any of the intermediate or final processing products of the methods described herein, such as the polar coordinate-transformed MR data, cell measurement data, etc.

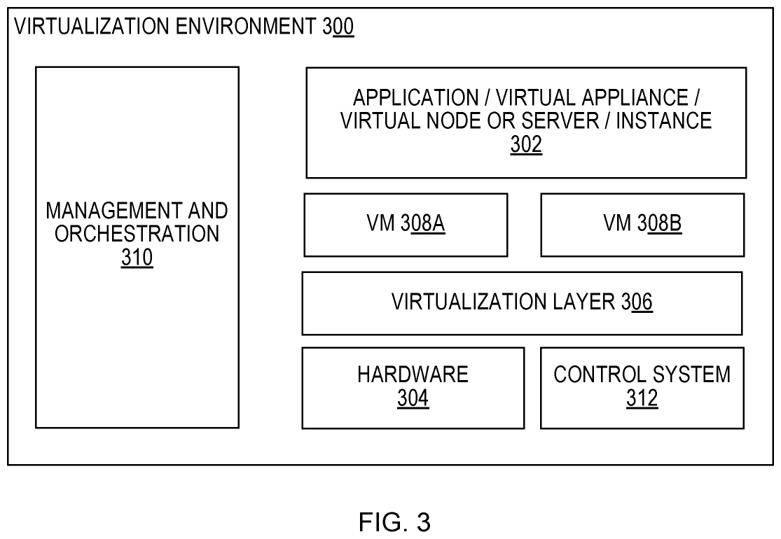

FIG. 3 is a block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. In particular, virtualization can be applied to an apparatus as described herein. Some or all of the functions described herein may be implemented as virtual components executed by one or more virtual machines (VMs) implemented in one or more virtual environments 300 hosted by one or more of hardware nodes, such as a hardware computing device that operates as a core network node. In further embodiments, the node may be entirely virtualized.

Applications 302 (which may alternatively be called software instances, virtual appliances, network functions, virtual nodes, virtual network functions, etc.) are run in the virtualization environment 300 to implement some of the features, functions, and/or benefits of some of the embodiments disclosed herein.

Hardware 304 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 306 (also referred to as hypervisors or virtual machine monitors (VMMs)), provide VMs 308a and 308b (one or more of which may be generally referred to as VMs 308), and/or perform any of the functions, features and/or benefits described in relation with some embodiments described herein. The virtualization layer 306 may present a virtual operating platform that appears like networking hardware to the VMs 308.

The VMs 308 comprise virtual processing, virtual memory, virtual networking or interface and virtual storage, and may be run by a corresponding virtualization layer 306. Different embodiments of the instance of a virtual appliance 302 may be implemented on one or more of VMs 308, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 308 may be a software implementation of a physical machine that runs programs as if they were executing on a physical, non-virtualized machine. Each of the VMs 308, and that part of hardware 304 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 308 on top of the hardware 304 and corresponds to the application 302.

Hardware 304 may be implemented in a standalone network node with generic or specific components. Hardware 304 may implement some functions via virtualization. Alternatively, hardware 304 may be part of a larger cluster of hardware (e.g. such as in a data center or customer premises equipment—CPE) where many hardware nodes work together and are managed via management and orchestration 310, which, among others, oversees lifecycle management of applications 302.

Thus in some embodiments, the apparatus 200 or virtualisation environment 300 can process MRs to derive cell measurement data, and/or process the cell measurement data to produce a cell RF coverage analysis classification result, which can include the categories of cell orientation, coverage and quality.

The classification result may subsequently be used by network engineers to adjust the operation or configuration of the cell to improve or optimise the network performance. In some implementations, the operation or configuration of the cell could be adjusted automatically, i.e. without requiring manual actions by an engineer.

Table 1 below is an example of measurement reports (MRs) that can be obtained for a cell in a communication network. Each MR in Table 1 includes the following information: a timestamp indicating when the MR was obtained, a serving eNB identity (senbid—which is an identifier of a serving base station—eNB—providing the cell that was measured), a serving cell identity (scellid—which is an identifier of the serving cell that was measured), a frequency identifier (that identities a frequency channel used in the cell—in some embodiments this frequency identifier is an E-UTRA Absolute Radio Frequency Channel Number (earfcn)), a physical cell identifier/identity (PCI), a signal strength (RSRP) measurement, a signal quality (RSRQ) measurement, and geolocation information indicating the location at which the measurements were obtained (expressed in longitude and latitude).

TABLE 1
Example MRs

| no. | Timestamp | senbid | scellId | earfcn | pci | rsrp | rsrq | longitude | Latitude |
|---|---|---|---|---|---|---|---|---|---|
| 0 | 2021-03-03 12:30:05.120 | 92243 | 433 | 41333 | 482 | −95.5 | −8.75 | 115.147324 | 23.020901 |
| 1 | 2021-03-04 10:02:13.120 | 92243 | 433 | 41333 | 482 | −89.5 | −6.75 | 115.144792 | 24.023530 |
| 2 | 2021-03-04 10:05:37.920 | 92243 | 433 | 41333 | 482 | −101.5 | −6.75 | 116.143827 | 24.023991 |
| 3 | 2021-03-04 14:21:08.640 | 92243 | 433 | 41333 | 482 | −98.5 | −7.75 | 116.142689 | 24.023358 |
| 4 | 2021-03-04 05:10:29.760 | 92243 | 433 | 41333 | 482 | −98.5 | −7.75 | 116.142303 | 24.023079 |
| . . . | . . . | . . . | . . . | . . . | . . . | . . . | . . . | . . . | . . . |

Table 2 below contains examples of cell configuration information for cells in the communication network. In Table 2, each cell configuration entry comprises several pieces of information that are also found in the MRs, namely EnodeBID, CellId, EARFCN, and PCI. Each cell configuration entry also comprises geolocation information for the cell antenna, which in this example is expressed in longitude and latitude, an azimuth angle for the cell antenna (typically measured with respect to due north), an antenna height (the height of the antenna above the ground), ETILT (which is an electrical/electronic tilt angle of the antenna) and MTILT (which is a mechanical tilt angle of the antenna).

TABLE 2
Example cell configuration information

| | | | | | | | | Antenna | | |
|---|---|---|---|---|---|---|---|---|---|---|
| no | EnodeBID | CellID | EARFCN | PCI | Longitude | Latitude | Azimuth | Height | ETILT | MTILT |
| 0 | 546822 | 131 | 3590 | 189 | 114.10770 | 32.99210 | 50 | 48 | 6 | 8 |
| 1 | 546822 | 132 | 3590 | 190 | 114.10770 | 32.99210 | 140 | 48 | 6 | 8 |
| 2 | 546822 | 133 | 3590 | 191 | 114.10770 | 32.99210 | 240 | 48 | 6 | 11 |
| 3 | 546706 | 131 | 3590 | 468 | 114.04861 | 33.04971 | 20 | 25 | 6 | 2 |
| 4 | 546706 | 132 | 3590 | 469 | 114.04861 | 33.04971 | 160 | 25 | 6 | 5 |
| . . . | . . . | . . . | . . . | . . . | . . . | . . . | . . . | . . . | . . . | . . . |

Table 3 below provides definitions for various symbols used in the following description.

TABLE 3
Symbol definitions

| Symbol | Definition | Remark |
|---|---|---|
| α | The original antenna azimuth of the serving cell | |
| θ | The angular coordinate in polar coordinates | |
| r | radial coordinate in polar coordinates | |
| (i, k) | i stands for cell i, k is the kₜₕ MRs in cell i | |
| Mᵢₖ | the kₜₕ MR records of cell i | |
| Dᵢ | the collection of all MRs in cell i | Dᵢ = {Mᵢ₀, Mᵢ₁ . . . Mᵢₖ} |
| r_{obs}, r_{covi}, rₐₙₜᵢ | The cell radius of observation, cell distribution and | |
| | antenna configuration | |
| C_{obs} | Function to calculate r_{obsi} with the input of | |
| | (r_{covi}, rₐₙₜᵢ) | |
| (a, d) | the encoded geo-location information a, d ∈ | in an array of (12, 12, 3), a is the |
| | 0, 1 . . . , 11 | position of azimuth and d is the radius |
| β_{α} | the angular axis of bins | |
| L_{d} | factor to calculate the radius axis of bins | |
| d_{id} | the radius axis of bins in cellᵢ | |
| (i, j) | i stands for cellᵢ, j is the bin identity | j could be deducted by (a, d) and |
| | | j ∈ {0, 1, . . . , 143} |
| Bᵢⱼ | Bins with id number i and j | j^{th} bin in cell i |
| Xᵢⱼ | Binned triplet elements | (RSRP, RSRQ, Density) in bin j of cell |
| | | i |
| Xᵢ | cellᵢ's data array with shape (12, 12, 3) | Xᵢ = {Xᵢⱼ}, j ∈ {0, 1, . . . , 143}; |
| | | indices of flatten 2-dimensional array |
| | | of 12 × 12 |
| Yᵢ | cellᵢ's RF analysis issue label, a triplet element | In the order of orientation, coverage |
| | | distance and quality with (8, 4, 4) |
| | | categories |
| X | Training dataset X (data array) | X = {Xᵢ} |
| Y | Training dataset Y (class labels) | Y = {Yᵢ} |

### Coordinates Transformation

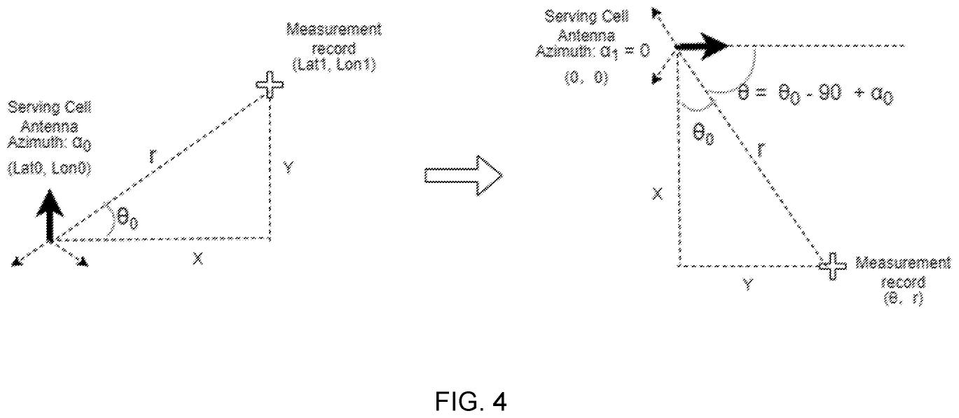

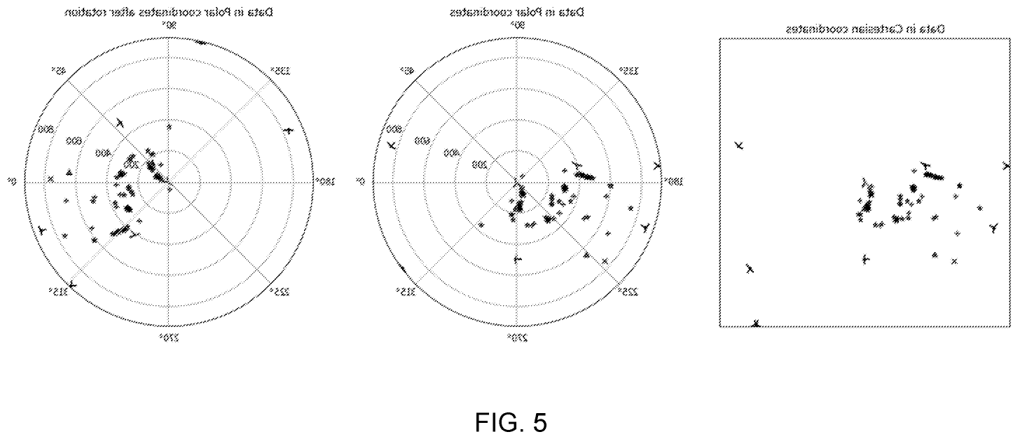

Thus, in Table 1 the raw measurement reports have the geolocation in Cartesian coordinates: latitude (lat) and longitude (lon). This is the same for the cell configuration information, where the geolocation for the cell site is given in Cartesian coordinates: latitude (lat) and longitude (lon). As mentioned above, as the cell orientation is to be checked, which is the actual coverage orientation deviation to the cell's design angle, and the coverage distance is to be checked, which is the actual coverage area radius compared to the cell's design radius, polar coordinates are a better choice for both kinds of comparison. The transformation to polar coordinates and rotation to a common azimuth angle is discussed below with respect to FIG. 4, and transformation and rotation of a set of MRs is shown in FIG. 5.

In the transformation, each MR's latitude and longitude location information are transformed to θ and r, with the serving cell as the pole, which means the serving cell's coordinates in polar coordinates are (0,0). The radius r is simple to calculate, as it is the distance between the geolocation of the MR and the geolocation of the serving cell. For θ, the serving cell's antenna direction is used as the polar angle reference direction.

The following steps set out an exemplary implementation of the transformation to polar coordinates and rotation.

Firstly, the geolocation of the measurement record is transferred from latitude and longitude to x, y, as follows:

$$X = degree 2 distance ( {lon}_{1} - {lon}_{0} ) \qquad ( 1 )$$

$$Y = degree 2 distance ( {lat}_{1} - {lat}_{0} ) \qquad ( 2 )$$

where lon₁ and lat₁ are the measurement record's longitude and latitude information, lon₀ and lat₀ are the serving cell's longitude and latitude information, and degree2distance( ) transfers the latitude, longitude degrees to distance in meters, m.

Next, the polar coordinate of the MR is calculated as follows:

$$r = \sqrt{{x}^{2} + {y}^{2}} \qquad ( 3 )$$

$$θ = arctan ( \frac{y}{x} ) - ( 90 - α ) \qquad ( 4 )$$

where α is the serving cell's antenna azimuth. The coordinate transformation is shown in FIG. 4, with the illustration on the left showing the original latitude/longitude measurements and the right illustration showing the polar coordinate transformed and rotated location.

The MRs for a particular cell in polar coordinates will form one data training sample Dᵢ after further operations, Dᵢ={Mᵢ₀, Mᵢ₁, . . . , Mᵢₖ}, and Mᵢₖ is the kₛₜ MR of serving cell j. Mᵢₖ includes (rᵢₖ, θᵢₖ, rsrpᵢₖ, rsrqᵢₖ) quadruple information, which is the polar coordinates information of {r, θ}, and the RF measurement information of RSRP and RSRQ.

The plots in FIG. 5 show the effects of the transformation and rotation with the real data. The left plot in FIG. 5 shows the original cell and measurement data in rectangular coordinates. The central plot shows the polar coordinates with East as the polar coordinates' angular reference, while the right plot shows the final coordinates after angular normalisation, which aligns the polar angular reference angle to the serving cell's orientation.

### Cell Observation Radius Definition

TABLE 4
Radius definitions

| Symbol | Definition |
|---|---|
| cell distribution | considering its surrounding cells |
| density radius | |
| antenna configuration | considering antenna height and downtilt |
| radius | |
| coverage radius | estimated serving cell coverage area radius |
| antenna radius | free space loss and trigonometry of estimating |
| | propagation distance |
| observation radius | composite radius considering both coverage |
| | radius and antenna radius |

To analyse the serving cells' coverage issue, just considering the signal strength (rsrp) is not enough, and this also needs to be compared to the MR's distance (r) to the cell radius. There are two kinds of cell radius, which is the cell distribution density radius (considering its surrounding cells) and its antenna configuration radius (considering antenna height and downtilt). Another cell observation radius is also defined, which considers both of the previous mentioned types of cell radius. The Mᵢₖ distribution is analysed within this observation radius, together with its rsrpᵢₖ strength, to determine if there is any coverage issue.

With a database of cell configuration information for cells in the communication network, all geolocation information, antenna height, downtilt details, etc. for the cells in the network is available. For the ith serving cell and the geolocation information of its surrounding cells, one serving cell's radius can be calculated, and this is referred to as coverage radius r_{covi}. Using the serving cell's antenna setting it is possible to calculate another cell radius, referred to as the antenna radius rₐₙₜᵢ. Considering both of these types of cell radius, a formula C_{obs}(r_{covi}, rₐₙₜᵢ) is provided to calculate the final observation radius r_{obsi} of cell i.

As shown in equation (5) below, C_{obs}(r_{covi}, rₐₙₜᵢ) will use (r_{covi}, rₐₙₜᵢ) to calculate a baseline value, and with this baseline value choose a multiplication factor, so as to deduct the observation radius properly, which is multiple times the size of the cell coverage or antenna radius. With this optimum observation radius, it is possible to analyse if there are any MRs exhibiting overshooting, where the cell has a much larger distance than planned, and at the same time, make sure that the observation radius is not too large, which will degrade the resolution ratio to the coverage details. Therefore each serving cell will have its specific observation radius r_{obsi}.

$${r}_{obsi} = {C}_{obs} ( {r}_{covi} , {r}_{anti} ) \qquad ( 5 )$$

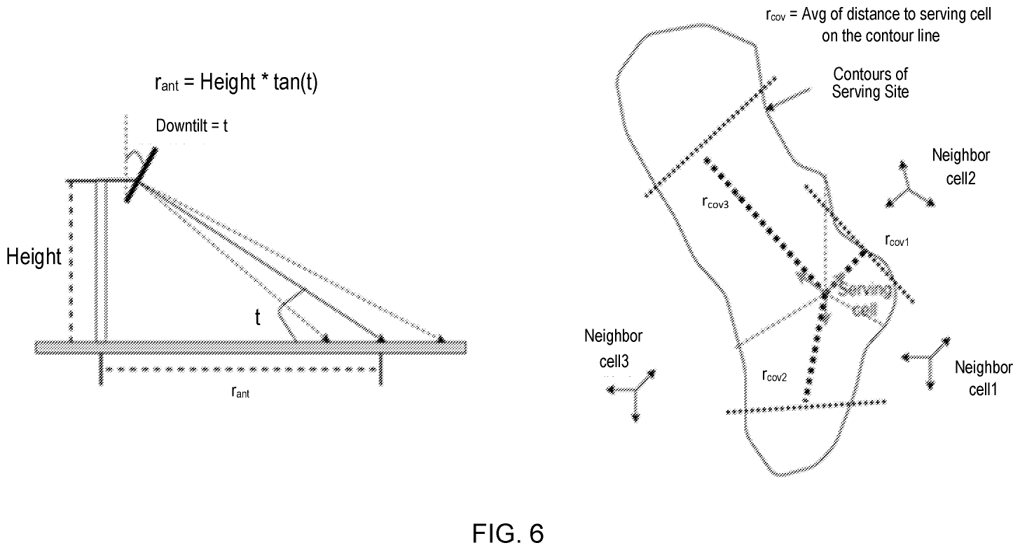

FIG. 6 illustrates the cell antenna and coverage radius calculation. The left part of FIG. 6 illustrates the calculation of rₐₙₜ for cell i. As shown on the right a contour outline can be formed according to the serving cell and the distribution of surrounding cells (with i=1, 2, 3). With this contour, the serving cell's coverage radius could be calculated.

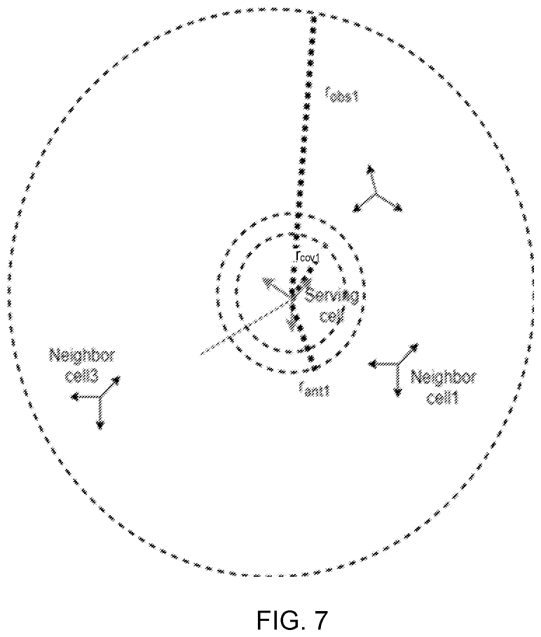

FIG. 7 illustrates the calculation of the cell observation radius, r_{obs}, for a cell i. As shown in FIG. 7, the observation radius is much larger than the other types of radius, and in this example the neighbour cells are located within the observation radius.

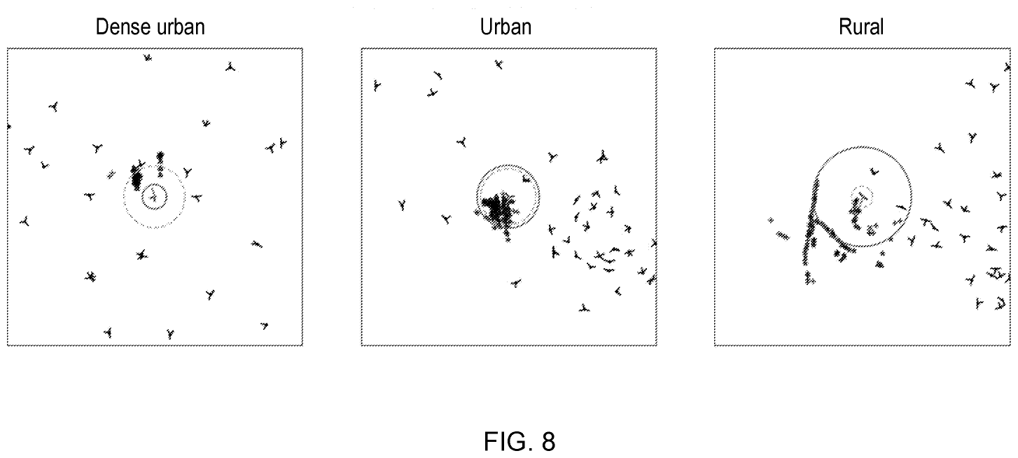

FIG. 8 illustrates the calculation of the observation radius from MRs in three scenarios, a cell in a dense urban environment (the left plot), a cell in an urban environment (the middle plot), and a cell in a rural environment (the right plot). In each plot, the solid circle is the cell coverage radius, and the dashed circle is the cell antenna coverage radius, while the full plot displays the observation radius. Thus, it can be seen that with different (r_{covi}, rₐₙₜᵢ), the r_{obsi} is also different.

### Data Binning

Turning now to the data binning, data binning is a standard practice in analysing cell RF coverage—which means aggregating the scattered measurement records to segmented areas on the geo-map—which not only solves imbalanced data distribution issues, but also reduces the data volume. However, compared to traditional binning methods, the binning according to the techniques described herein define the bins in the polar coordinate system, with each bin being an annular sector of the cell's coverage area, and which results in bins having non-uniform sizes. The use of a non-uniform (variable) interval in spatial binning has three advantages:
binning is performed in the polar coordinates system, which means that the bin size becomes larger the further the bin is from the cell's antenna, as the bin's arc length increases;
in the radial direction, the distinction of radial distance to split the bin is also larger the further bin is away from the cell's antenna; and.
the number of bins for each data sample (i.e. each collection of MRs for a particular cell) can be fixed, regardless of the observation cell radius. In the following embodiments, the number of bins is 12*12. Since each cell has a different observation cell radius r_{obs}, the bin size in different cells will also be different.

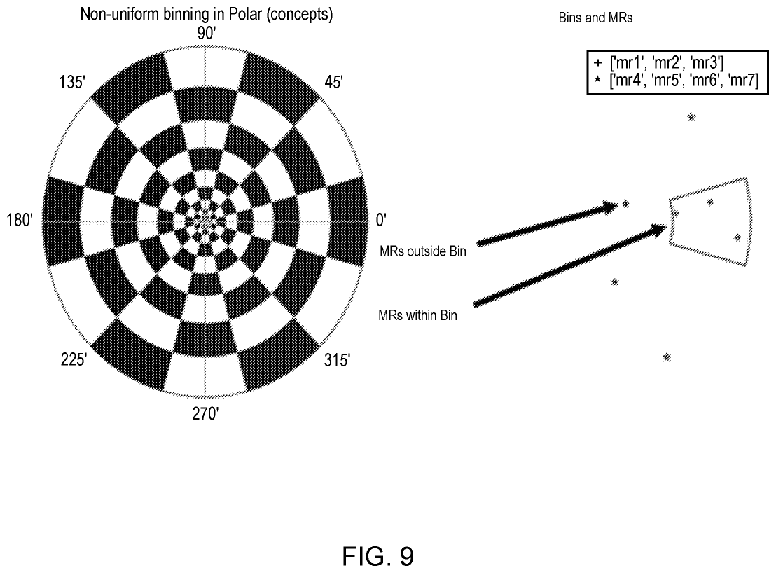

The following description provides an example of data binning for a serving cell, cellᵢ, with a 12*12 bin arrangement. FIG. 9 illustrates a 12*12 bin arrangement for cellᵢ, where each bin is an annular sector of a notional circular coverage area of the cell.

First, in the angular axis, the 360° circumference of the circle centred on the cell antenna was divided into 12 equal arcs, which means the angular gradation of each arc is 30°, with angular axes of β, α∈{0,1,2 . . . ,11}. Then, in the radial axis, 12 distinct distances are pre-defined, with a factor parameter L_{d}, d∈{0,1, . . . ,11} and L₁₁−L10≥. . . ≥L₂−L₁≥L1−L0, with L₁₁≤1. Then with the observation radius r_{obs} for cellᵢ, the cell specific d_{id} can be calculated as follows:

$${d}_{id} = {r}_{obsi} \times {L}_{a} , d ∈ \{ 0 , 1 , … , 11 \} \qquad ( 6 )$$

Therefore, this means that the depth (i.e. in the radial direction) of each bin increases with the distance from the cell's antenna.

Each measurement record Mᵢₖ in the sample data Dᵢ will be assigned to a bin identified by coordinates of the form (â, \hat{b}), where θᵢₖ∈(â, â−1) and rᵢₖ∈(\hat{d}, \hat{d}−1). This means that Mᵢₖ with (rᵢₖ, θᵢₖ, rsrpᵢₖ, rsrqᵢₖ) quadruple information will be transferred to a quadruple (iâ, i\hat{d}, rsrpᵢₖ, rsrqᵢₖ).

The measurements with the same binning location information of (â, \hat{d}) will be aggregated to generate a new data sample Bᵢⱼ with (aᵢⱼ, dᵢⱼ, rsrpᵢⱼ, rsrqᵢⱼ, denᵢⱼ), where the last 3 elements (rsrpᵢⱼ, rsrqᵢⱼ, denᵢⱼ) describe the MR distribution in bin (aᵢⱼ, dᵢⱼ) and j∈{0,1,2, . . . ,143}, j is the bin identity.

Here the aggregate values rsrpᵢⱼ, rsrqᵢⱼ could be the average (mean), median, or max value of those values of the measurement records in the same bin; and denᵢⱼ is the density value. The calculation methods can be:

$${rsrp}_{ij} = max ( {rsrp}_{ik} ) , {rsrp}_{ik} ∈ {Bin}_{ij} \qquad ( 7 )$$

$${rsrq}_{ij} = median ( {rsrq}_{ik} ) , {rsrq}_{ik} ∈ {Bin}_{ij} \qquad ( 8 )$$

$${den}_{ij} = \frac{count ( {rsrp}_{ik} )}{count ( {rsrp}_{i} )} , {rsrp}_{ik} ∈ B i {n}_{ij} , {rsrp}_{i} ∈ {cell}_{i} \qquad ( 9 )$$

Referring to the example bin on the right side of FIG. 9, the RSRP, RSRQ and the density of the bin is max(mr1, mr2, mr3), median(mr1, mr2, mr3) and

$$\frac{count ( mr 1 , mr 2 , mr 3 )}{count ( mr 1 , mr 2 , … , mr 7 )} = \frac{3}{7} = 42.9 \% .$$

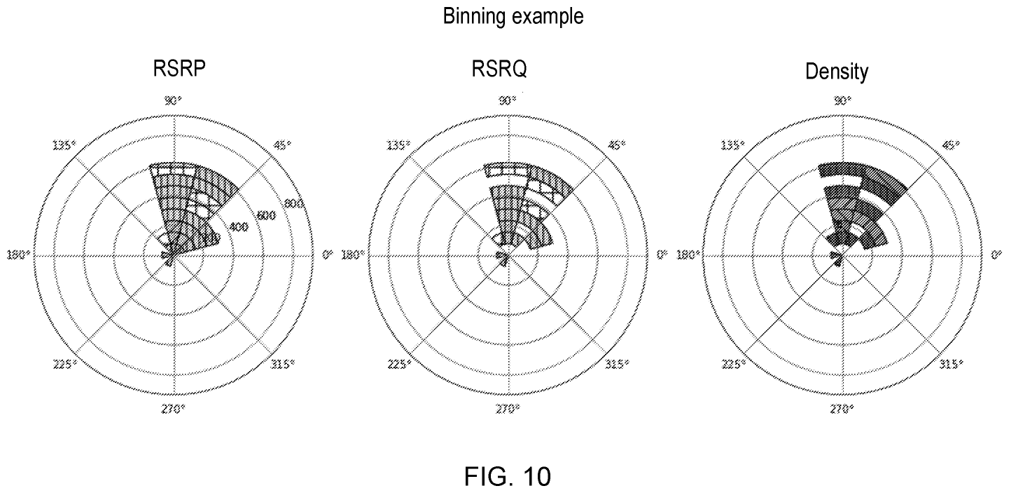

FIG. 10 is a visualisation of the binning in a data sample for RSRP, RSRQ and Density. Each part is one bin, with the bins being distinguished by different shading, and the darkness of the shading representing the characteristics of the bin. It should be noted that some adjacent bins have the same characteristics, so they are merged together in the plot, and appear to be a larger bin.

After data binning, each data sample Bᵢⱼ can be further transferred to training data sample Xᵢⱼ (also referred to herein as “cell measurement data”), where Xᵢ is one data array with the shape determined by the number of bins and the number of information types (i.e. 3 in the current example: RSRP, RSRQ and Density), and j can deduce the position of the array (recalling that j∈{0,1, . . . ,143}), because j can be calculated by (a, d) where (a, d) decides the exact location of Xᵢⱼ in the array (a is the first dimension position, and d is the second dimension position in the array or matrix). In the current example, data array Xᵢ has a shape (12, 12, 3).

Thus, it can be seen that each sample's geolocation is actually encoded into the array position, which significantly simplifies the complexity of the input data. The array's third dimension has position, which indicates whether the information type at the corresponding position is RSRP, RSRQ or density respectively. As noted above, this type of array structure is similar to the 3 channels in a RGB image.

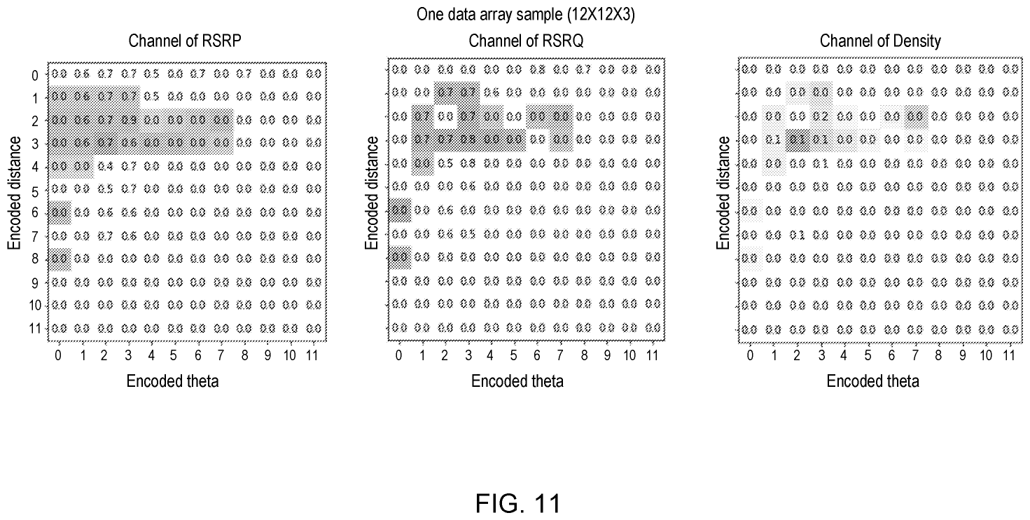

FIG. 11 shows an exemplary data array with 3 channels, one for each of RSRP, RSRQ and density. The polar coordinates of each bin are encoded in the array's position (i.e. the location of the 1st and 2nd dimensions in the matrix),

### Multi-Channel Inputs

The third dimension of the input data sample Xᵢ (which in the present examples is a 12*12*3 array) has 3 positions, which allocates 3 types of information, namely RSRP, RSRQ and density, respectively. As mentioned earlier, the position of the first and second dimension of the array defines the geolocation of the jₜₕ bin (binᵢⱼ) for cellᵢ. In each bin, statistical data for multiple MRs' RSRP and RSRQ values can be calculated. For example, the mean or other average of the RSRP values for the MRs in that bin can be calculated, likewise for the RSRQ. With RF engineers' experience and data, analysis, the statistical values of RSRP, RSRQ and sample volume (normalised to density) are finally selected. The statistical value of RSRP in binᵢⱼ will be allocated into the first position of the third dimension, and the statistical value of RSRQ and density will in the second and third positions respectively. This form of data structure places all three types of MR statistics information at the input array's third dimension, similar to the RGB channels in an image. Extracting the first channel's data (one 12*12 array) would result in the cell's RSRP distribution information; extracting the second channel's data (another 12*12 array) would result in the RSRQ distribution, and extracting the third channel's data would result in the density. During subsequent clustering or classification steps of the model training, the information for all three channels will be processed in one input data sample Xᵢ. So the inter-correlations of the three types of information could be captured and used to enhance the model's recognition capability and achieve the complete cell RF performance analysis task.

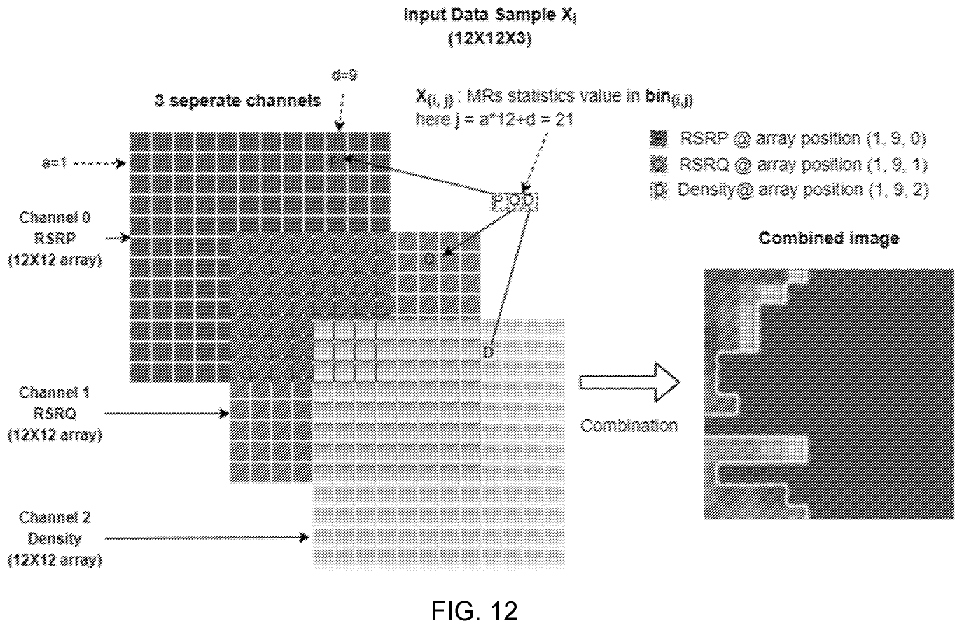

FIG. 12 illustrates the allocation and combination of data into a three channel input array. The RSRP channel, RSRQ channel and density channel are labelled Channel 0, Channel 1 and Channel 2 respectively.

### RSRP Interpolation

During data processing, it has been found that the distribution of measurement records throughout the cell was often sparse, which means not many bins actually have MR data. Therefore, embodiments provide for the use of interpolation techniques to improve the data distribution. In particular embodiments, the interpolation is applied to the RSRP channel. In particular embodiments, the interpolation is applied in the radial direction, and/or in the angular direction. Therefore a continuous data distribution can be obtained, which can help the trained model to better detect any issues with the cell.

As an example, consider that there is data in Bin(aᵢⱼ, d_{ij′}) and Bin(aᵢⱼ, dij″) and d_{ij″}>d_{ij′}, but there is no data in Bin(aᵢⱼ, dᵢⱼ) where d_{ij″}>dᵢⱼ>d_{ij′}.

Therefore, the data in bin (aᵢⱼ″, dᵢⱼ″, rsrp_{ij″}) and (aᵢⱼ′, dᵢⱼ′, rsrp_{ij′}) could be used to interpolate the data for bins of (aᵢⱼ, dᵢⱼ, rsrpᵢⱼ). In this way, continuous RSRP coverage can be obtained for the cell. The ability to interpolate in this way is one of the advantages of polar coordinates transformation.

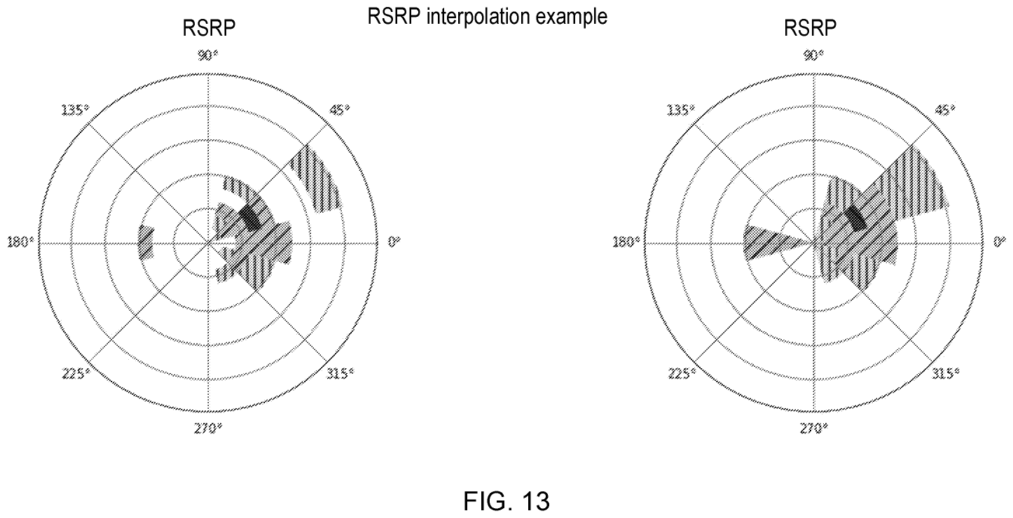

FIG. 13 illustrates the effect of interpolation of RSRP values. The left plot in FIG. 13 shows the binned RSRP values obtained from the MRs. It can be seen that there are gaps in the data continuity in the radial direction. By using interpolation in the radial direction, those gaps can be filled with interpolated RSRP values, providing a more complete data set for the training of the ML model.

### Sample Labelling by Clustering

Now the training dataset X={Xᵢ} has been obtained, where, in some embodiments, Xᵢ is a 12*12*3 data array of cell i. However, a further dataset is required, dataset Y={Yᵢ}, where Yᵢ is the RF issue class of cell i. That is, information is required on the RF issues being experienced in the cell (e.g. in terms of the orientation, quality and coverage) to provide context for the data sample. As three types of RF issues are considered herein, Y also has three branches, which could be described in a list of dictionaries (e.g. a mapping dictionary for Y label) as shown in Tables 5, 6 and 7 below. However, it will be appreciated that more or less than three types of RF issue can be considered for dataset Y, including different RF issues to those listed above and exemplified below.

TABLE 5
Orientation issue classes

| Index | Definition | Remark |
|---|---|---|
| 0 | Antenna direction | no issue |
| 1 | Counter- | antenna rotated about 60° in |
| | clockwise 60° (40°~70°) | counter-clockwise direction |
| 2 | Clockwise 60° (40°~70°) | antenna rotated about 60° in |
| | | clockwise direction |
| 3 | Reverse (150°~210°) | antenna is in the reverse direction |
| 4 | Clockwise 120° (105°~150°) | antenna rotated about 120° in |
| | | clockwise direction |
| 5 | Counter- | antenna rotated about 90° in |
| | clockwise 90° (70°~105°) | counter-clockwise direction |
| 6 | Counter- | antenna rotated about 120° in |
| | clockwise 120° (105°~150°) | counter-clockwise direction |
| 7 | Clockwise 90° (70°~105°) | antenna rotated about 90° in |
| | | clockwise direction |

TABLE 6
Coverage distance issue classes

| Index | Definition | Remark |
|---|---|---|
| 0 | Severe | the cell has a severe overshooting issue, about |
| | over- | 33% of MR samples are in the second half of the |
| | shooting | observation radius and the last quarter's mean |
| | | RSRP power is above −90 dBm |
| 1 | Mild | the cell has a mild overshooting issue, about |
| | over- | 14% of MR samples are in the second half of the |
| | shooting | observation radius and the last quarter's mean |
| | | RSRP power is above −90 dBm |
| 2 | Normal | the cell has no overshooting issue |
| 3 | Limited | the cell has a limited coverage issue, about |
| | Coverage | 90% of MR samples are in the first quarter of the |
| | | observation radius and from 2nd quarter the mean |
| | | RSRP power is below −90 dBm |

TABLE 7
Quality (interference) issue classes

| Index | Definition | Remark |
|---|---|---|
| 0 | Good | the cell's interference quality is good, almost all |
| | | MR bins RSRQ is above −9 dB |
| 1 | Typical | the cell's interference quality is typical |
| 2 | Bad | the cell's interference quality is bad, in the first |
| | | quarter of the observation radius the average RSRQ is |
| | | below −10 dB and from the 2nd quarter the average |
| | | RSRQ is below −12 dB |
| 3 | Severe | the cell's interference quality is very bad, in the |
| | | first quarter of the observation radius the average |
| | | RSRQ is below −12 dB and from the 2nd quarter the |
| | | average RSRQ is below −13 dB |

It should be noted that the Remarks in the above tables (Table 5, Table 6 and Table 7) are different sample clusters from a semi-supervised learning output, for the domain expert (e.g. RF engineer) to determine the target dataset label, and to explain each label and features distribution relevant to each label.

The following two sections provide methods for annotating the dataset.

### Anomaly Selection

To process the large amount of data samples, most of which relate to ‘normal’ cells (i.e. cells with no significant RF issues), an autoencoder anomaly detection technique can be used select those typical samples, which enables the ‘noise’ in the data samples (i.e. the normal cells) to be removed and enables the cells with potential issues to be easily detected.

An autoencoder is a type of neural network that is trained to copy its input to its output. For example, given an image of a handwritten digit, an autoencoder first encodes the image into a lower dimensional latent representation, and then decodes the latent representation back to an image. The autoencoder learns to compress the data (image) while minimising the reconstruction error.

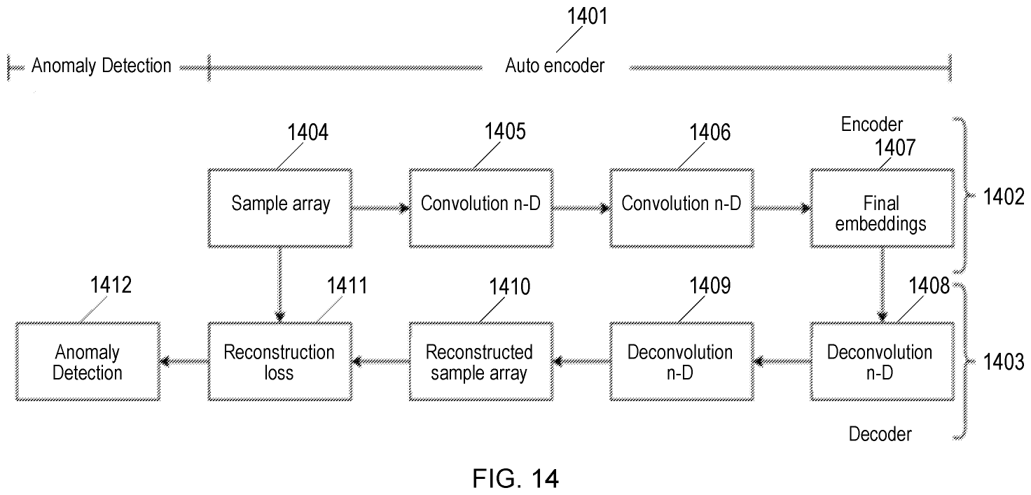

FIG. 14 illustrates an autoencoder architecture 1401 for anomaly detection according to some embodiments. The autoencoder 1401 comprises an encoding stage 1402 followed by a decoding stage 1403. The sample array 1404 (i.e. the training dataset X={Xᵢ}) is input to a series of encoding blocks 1405, 1406 that operate to compress the sample array to reduce the dimensionality of the sample array 1404 to form a final embedding 1407. The final embedding 1407 is also referred to as the latent representation.

The final embedding 1407 is then input to a series of decoding blocks 1408, 1409 in the decoding stage 1403 that decode the final embedding 1407 to reconstruct the original sample array. A reconstruction loss is calculated in block 1411 which represents the loss between the sample array 1404 to the reconstructed sample array. The autoencoder 1401 is trained to determine an encoding and decoding that minimises the reconstruction loss.

With the optimised (minimised) reconstruction error, anomalous samples can be detected. Thus, the reconstructed sample array is provided by the trained autoencoder 1401 to an anomaly detection block 1412 that detects the cells in the sample array that potentially have RF issues. The potentially anomalous samples are those samples that have a high reconstruction loss when passed through the autoencoder 1401. Those potentially anomalous samples will be used to form a reduced dataset compared to the original sample array 1404, which greatly reduced the effort required to label the samples. In practice, in order to include all the representative characteristics in the final dataset, the final dataset include all the potentially anomalous samples, and some of the ‘normal’ samples by sampling selection, since ‘normal’ is one of the output categories of the trained model.

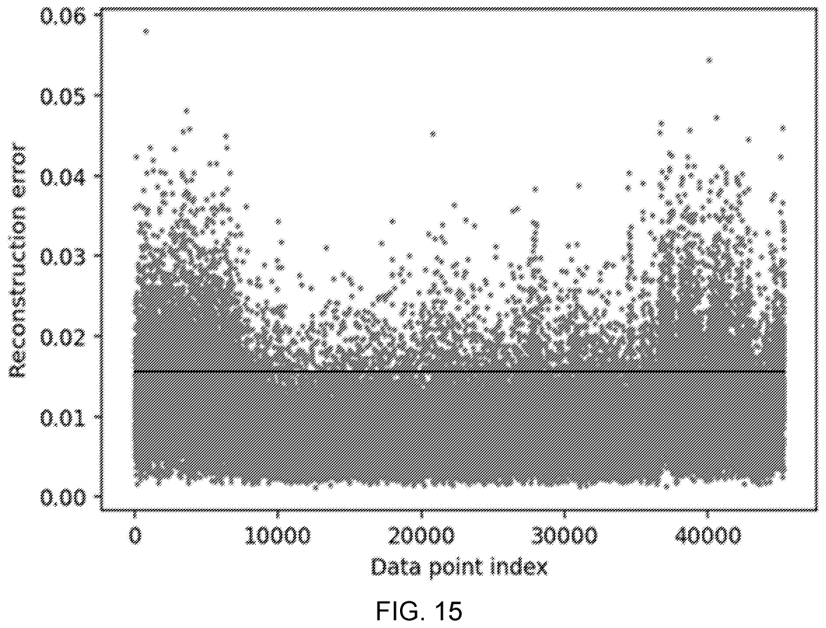

The plot in FIG. 15 illustrates the output of autoencoder 1401 (in terms of the reconstruction loss per sample) for an exemplary sample array 1404. In this example, the reconstruction loss is a mean absolute error (MAE) loss, and the samples having a reconstruction loss above the threshold line at ˜0.016 are selected as potentially anomalous.

### Clustering

In some embodiments, a clustering block or clustering layer can be added to the autoencoder architecture 1401 in FIG. 14. The clustering layer receives the final embeddings determined in block 1407 (the final embeddings are also still passed to the decoding stage 1403). Thus, the clustering layer will receive the lower-dimensional latent representation as the input, and jointly optimise two loss functions. One is the reconstruction loss of the autoencoder 1401, and the other is the clustering loss. After minimising of the total loss, the input samples (i.e. sample data arrays for multiple cells) can be attributed to different clusters.

For each cluster, an engineer's RF experience can be used to analyse the common profile of the samples in the cluster, which are the RF issues of the cells in the cluster, and give the cells in the cluster initial labels. This provides the initial labels set Yᵢₙᵢₜ.

### Model Training

With X and Yᵢₙᵢₜ as derived above as the input training data, a deep learning convolution neural network (CNN) with a skip connect architecture can be used to train a learning model. This training process can be operated in several runs. In each run, the optimised model is used to derive a prediction using the same X data. The difference between the prediction result Y_{pred} and the original input can be analysed based on domain knowledge. If the prediction result is more reliable, the label for the data sample will be corrected, which reflects the concept of semi-supervised learning. These measures can improve the accuracy of the labels significantly, considering the initial labels provided by the clustering algorithm typically generate some low accuracy labels.

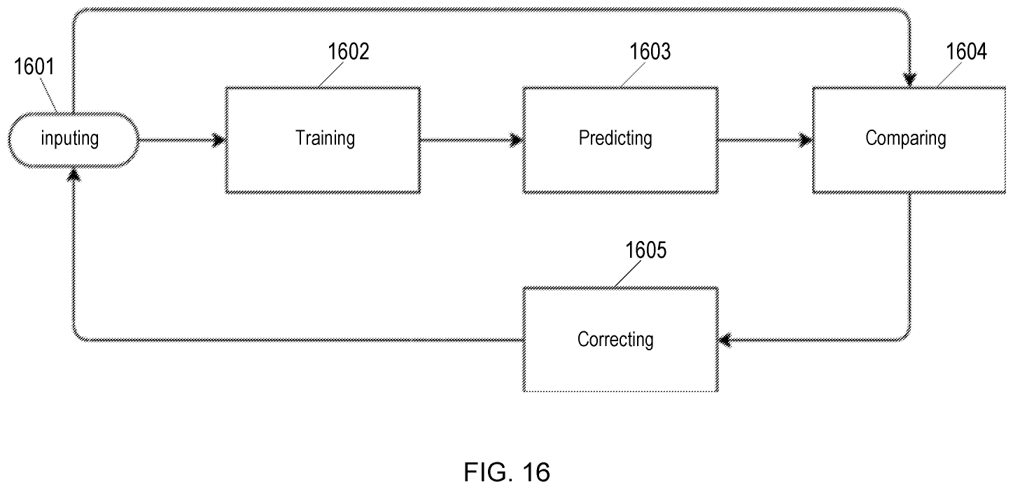

FIG. 16 shows an outline of the model training process. The training data 1601 (the labelled cell measurement data determined according to the above techniques) is input to a training block 1602 which responsible of the model training and generate the trained model. A prediction block 1603 uses the trained model generated by block 1602 to do the prediction, and the output of predicting block 1603 is compared in block 1604 to the label for the particular cell to determine how accurate the prediction 1603 is. The result of the comparison is passed to a correcting block 1605 which checks for inconsistencies and decides the final correct label. The output of block 1605—which is the training data with the corrected label—will be the new training data in block 1601. This is a closed loop during the model training process and finally generates a stable training dataset with final corrected labels. For this final training stable training dataset, block 1603, 1604 and 1605 are not performed, which means the output of block 1602 is the final trained model.

For the skip-connect deep learning CNN model, a single input multiple output architecture can be used, which means the model has a single input branch, which in the above examples is a 12*12*3 data array X, where the three channels consist of three types of related information. The model has three output branches, with, in the above examples, a category number of 8, 4 and 4, which are the predicted categories of orientation, distance and quality respectively; the three aspects of the cell RF coverage analysis of interest. In this architecture, the common layer helps them to extract the common characteristics and the different branches extract the particular characteristics, which increases the classification accuracy and simplifies the use of the model for making predictions. Through the use of a SIMO architecture, in the above example with one input there are actually 128 (8*4*4) possible outputs after combination, which is not possible to achieve when model training with a SISO architecture if the three branches (8, 4, 4) labels are flattened to 128 when most of the categories do not have not enough samples in the training data.

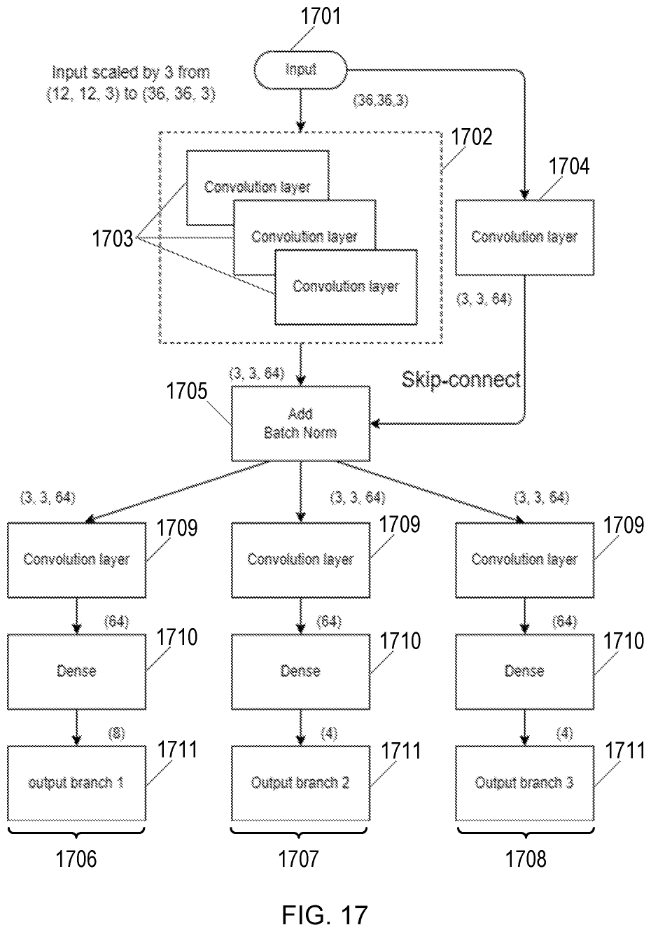

FIG. 17 illustrates an exemplary SIMO deep learning convolution neural network (CNN) with a skip connect architecture. The data sample X is input at block 1701. Due to the three output branches of the model, the first two dimensions of the input are scaled by three, so the input data array transforms from (12, 12, 3) to (36, 36, 3).

The data sample X is input to convolution block 1702 which comprises multiple convolution layers 1703 to extract the common features of the input information, which is a deep learning CNN network.

Block 1704 is a shortcut convolution layer that extracts the common features of the input information, which helps to build the skip-connect architecture. This shortcut convolution layer 1704 helps to tackle the vanishing gradient problem.

Block 1705 adds the output of the multiple convolution layers and the shortcut convolution layer 1704 together, which constructs the skip-connect architecture. In block 1705 there are also some other sub-layers, such as a batch normalization layer, which act as regularisation.

There are three output branches 1706, 1707, 1708, one for each of the desired model predictions, i.e. orientation, coverage and quality. Each branch 1706, 1707, 1708 comprises a convolution layer block 1709 for extracting the particular characteristics for the particular output branch, block 1710 is a layer to fully connect to the output of the convolution layer 1709 and generate the predicted output, and block 1711 is the predicted output result.

With a model trained as described above, experimental results have achieved an overall accuracy rate of 94.1% for the cell performance predictions. The following tables provide some details of the experimental results.

Firstly, Tables 8, 9 and 10 provide the Top 1 classification metrics based on the validation dataset.

TABLE 8
Classification metrics branch 0 (orientation)

| | | | f- | |
|---|---|---|---|---|
| class | precision | recall | score | support |
| Antenna direction | 0.989 | 1.000 | 0.994 | 948 |
| Clockwise 120° (105°~150°) | 0.920 | 0.964 | 0.942 | 84 |
| Clockwise 60° (40°~70°) | 0.941 | 0.954 | 0.947 | 151 |
| Clockwise 90° (70°~105°) | 0.948 | 0.902 | 0.925 | 102 |
| Counter-clockwise 120° (105°~150°) | 0.859 | 0.897 | 0.878 | 68 |
| Counter-clockwise 90° (70°~105°) | 0.957 | 0.838 | 0.893 | 105 |
| Counter-clockwise 60° (40°~70°) | 0.947 | 0.947 | 0.947 | 132 |
| Reverse (150°~210°) | 0.938 | 0.918 | 0.928 | 98 |
| accuracy | 0.965 | 0.965 | 0.965 | 1 |
| macro average | 0.937 | 0.928 | 0.932 | 1688 |
| weighted average | 0.965 | 0.965 | 0.965 | 1688 |

TABLE 9
Classification metrics branch 1 (coverage)

| class | precision | recall | f-score | support |
|---|---|---|---|---|
| Mild overshooting | 0.906 | 0.888 | 0.897 | 520 |
| Normal | 0.949 | 0.944 | 0.947 | 555 |
| Severe overshooting | 0.933 | 0.948 | 0.940 | 497 |
| Weak Coverage | 0.917 | 0.957 | 0.937 | 116 |
| accuracy | 0.929 | 0.929 | 0.929 | 1 |
| macro average | 0.926 | 0.934 | 0.930 | 1688 |
| weighted average | 0.929 | 0.929 | 0.929 | 1688 |

TABLE 10
Classification metrics branch 2 (quality)

| class | precision | recall | f-score | support |
|---|---|---|---|---|
| Good | 0.892 | 0.809 | 0.849 | 194 |
| Mild | 0.849 | 0.867 | 0.858 | 181 |
| Normal | 0.958 | 0.967 | 0.963 | 1160 |
| Poor | 0.897 | 0.915 | 0.906 | 153 |
| accuracy | 0.934 | 0.934 | 0.934 | 1 |
| macro average | 0.899 | 0.890 | 0.894 | 1688 |
| weighted average | 0.933 | 0.934 | 0.933 | 1688 |

Next, Tables 11, 12 and 13 provide the Top 2 classification metrics based on the validation dataset.

TABLE 11
Classification metrics branch 0 (orientation)

| | | | f- | |
|---|---|---|---|---|
| class | precision | recall | score | support |
| Antenna direction | 0.998 | 1.000 | 0.999 | 948 |
| Clockwise 120° (105°~150°) | 1.000 | 1.000 | 1.000 | 84 |
| Clockwise 60° (40°~70°) | 1.000 | 1.000 | 1.000 | 151 |
| Clockwise 90° (70°~105°) | 1.000 | 1.000 | 1.000 | 102 |
| Counter-clockwise 120° (105°~150°) | 1.000 | 0.971 | 0.985 | 68 |
| Counter-clockwise 90° (70°~105°) | 0.990 | 0.990 | 0.990 | 105 |
| Counter-clockwise 60° (40°~70°) | 1.000 | 1.000 | 1.000 | 132 |
| Reverse (150°~210°) | 1.000 | 1.000 | 1.000 | 98 |
| accuracy | 0.998 | 0.998 | 0.998 | 1 |
| macro average | 0.999 | 0.995 | 0.997 | 1688 |
| weighted average | 0.998 | 0.998 | 0.998 | 1688 |

TABLE 12
Classification metrics branch 1 (coverage)

| class | precision | recall | f-score | support |
|---|---|---|---|---|
| Limited Coverage | 0.991 | 1.000 | 0.996 | 116 |
| Mild overshooting | 1.000 | 0.998 | 0.999 | 520 |
| Normal | 1.000 | 1.000 | 1.000 | 555 |
| Severe overshooting | 1.000 | 1.000 | 1.000 | 497 |
| accuracy | 0.999 | 0.999 | 0.999 | 1 |
| macro average | 0.998 | 1.000 | 0.999 | 1688 |
| weighted average | 0.999 | 0.999 | 0.999 | 1688 |

TABLE 13
Classification metrics branch 2 (quality)

| class | precision | recall | f-score | support |
|---|---|---|---|---|
| Bad | 0.984 | 1.000 | 0.992 | 181 |
| Good | 1.000 | 1.000 | 1.000 | 194 |
| Severe | 1.000 | 0.961 | 0.980 | 153 |
| Typical | 0.997 | 0.999 | 0.998 | 1160 |
| accuracy | 0.996 | 0.996 | 0.996 | 1 |
| macro average | 0.995 | 0.990 | 0.992 | 1688 |
| weighted average | 0.996 | 0.996 | 0.996 | 1688 |

It can be seen from the above tables that if the issue type falls in the first or second classes, the performance estimation accuracy can reach almost 100%.

### Classification Result Examples

An optimised machine learning model can be used to predict performance issues for a new cell (i.e. a cell for which MR data is now available). The cell's MR data can be processed into cell measurement data according to the above techniques, for example resulting in array with shape 12*12*3, and this cell measurement data input to the trained model. The output of the model will be the top three classes, with a corresponding probability for three branches. Table 14 below provides an example of a prediction result for two cells.

TABLE 14
Output example

| | Cell1 | Cell2 |
|---|---|---|
| Cellid | 176128_11 | 176128_12 |
| Prob0_ori | 86.45% | 95.11% |
| Prob1_ori | 13.48% | 4.89% |
| Prob2_ori | 0.07% | 0.00% |
| ClassName0_ori | Counter-clockwise 60° | Antenna direction |
| | (40°~70°) | |
| ClassName1_ori | Antenna direction | Clockwise 60° |
| | | (40°~70°) |
| ClassName2_ori | Counter-clockwise 90° | Clockwise 90° |
| | (70°~105°) | (70°~105°) |
| Prob0_cov | 99.95% | 99.90% |
| Prob1_cov | 0.05% | 0.10% |
| Prob2_cov | 0.00% | 0.00% |
| ClassName0_cov | Normal | Normal |
| ClassName1_cov | Mild overshooting | Mild overshooting |
| ClassName2_cov | Limited Coverage | Limited Coverage |
| Prob0_qal | 88.09% | 77.22% |
| Prob1_qal | 11.78% | 22.44% |
| Prob2_qal | 0.13% | 0.34% |
| ClassName0_qal | Typical | Typical |
| ClassName1_qal | Bad | Bad |
| ClassName2_qal | Severe | Severe |

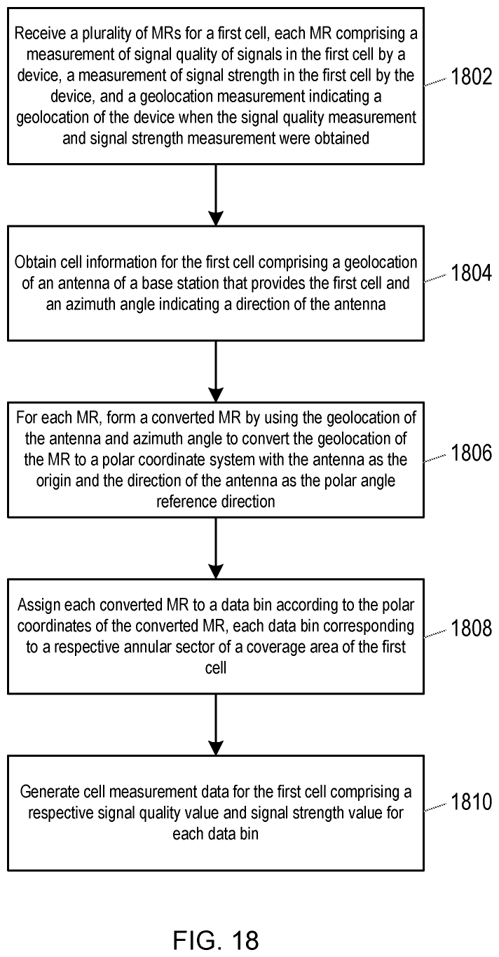

The flow chart in FIG. 18 illustrates a computer-implemented method of preparing cell measurement data for use with a ML according to various embodiments described herein. The method can be performed by any suitably configured computer or processor, for example in response to executing computer-readable code embodied or otherwise stored on a computer-readable medium. In some embodiments, the method in FIG. 18 can be performed by the apparatus 200 in FIG. 2 or the virtualization environment 300 in FIG. 3.

In step 1802, a plurality of measurement reports are received for a first cell in a communication network. Each measurement report comprises a measurement of signal quality of signals in the first cell by a device (e.g. a dedicated communication network testing device, or a mobile device, UE, etc.), a measurement of signal strength in the first cell by the device, and a geolocation measurement indicating a geolocation of the device when the signal quality measurement and signal strength measurement were obtained. It will be appreciated that while the measurements within a particular MR are obtained by the same device, the plurality of measurement reports may have been obtained by different devices. Typically the MRs are obtained from different geolocations covered by the cell. The MRs shown in Table 1 above are examples of MRs that can be received in step 1802.

In step 1804, cell information is obtained for the first cell. The cell information comprises a geolocation of an antenna of a base station that provides the first cell (e.g. the antenna that transmits the control signals for the first cell) and an azimuth angle indicating a direction of the antenna. The azimuth angle indicates the direction that the antenna is facing. The cell configuration information shown in Table 2 above is an example of the cell information that can be received in step 1804.

In step 1806, for each measurement report, a converted measurement report is formed by using the geolocation of the antenna and azimuth angle to convert the geolocation of the measurement report to a polar coordinate system. In the polar coordinate system the antenna is the origin of the polar coordinate system and the direction of the antenna is the polar angle reference direction. That is, the geolocation of the MR is converted to polar coordinates so that the value of r in the polar coordinates is the distance between the geolocation of the MR and the location of the antenna, and the value of θ in the polar coordinates is the angle of the MR from the direction of the antenna. Step 1806 can be performed as described above in the Coordinates transformation section.

In step 1808, each converted measurement report is assigned to a data bin according to the polar coordinates of the converted measurement report. Each data bin corresponds to a respective annular sector of a coverage area of the first cell, as in the example shown in FIG. 9 and described above in the Data binning section.

In step 1810, cell measurement data is generated for the first cell, with the cell measurement data comprising a respective signal quality value and signal strength value for each data bin. The signal quality value for a particular bin can be determined from the signal quality measurements of the MRs assigned to that bin, and likewise the signal strength value for that bin can be determined from the signal strength measurements of the MRs assigned to that bin. The generation of the signal quality values and signal strength values for the cell measurement data in step 1810 can be as described above in the Data binning section.

In some embodiments, the signal quality value can be an aggregate signal quality measurement generated from the signal quality measurements in the converted measurement reports assigned to the respective data bin. In some embodiments, the signal strength value can be an aggregate signal strength measurement generated from the signal strength measurements in the converted measurement reports assigned to the respective data bin. In some embodiments, each data bin in the cell measurement data can include a density value representing a number of converted measurement reports assigned to the data bin relative to a number of converted measurement reports assigned to other data bins for the cell.

In some embodiments, the total area of the data bins is based on an expected coverage area of the first cell. This expected coverage area can be the observation radius r_{obsi} determined as described above in the Cell observation radius definition section. Thus, in some embodiments, the expected coverage area of the first cell can be determined from an antenna height of the antenna, an antenna tilt angle and geolocations of one or more antennas of base stations that provide neighbouring cells to the first cell (which can all be indicated in the cell information obtained in step 1804).

In some embodiments, the number of data bins is the same for each cell in the communication network for which cell measurement data is determined. This means that the number of data bins is the same, regardless of the magnitude of the expected coverage area/observation radius r_{obsi}.

In some embodiments, the area covered by respective data bins increases with increasing distance from the antenna, as shown in FIGS. 9 and 10. In some embodiments, the radial distance (radial depth) of each data bin increases with distance from the antenna, as described above in the Data binning section.

In some embodiments, to fill in gaps in the MR data for the first cell, step 1810 can further comprise estimating a respective signal quality value and/or a respective signal strength value for one or more empty data bins from signal quality values and/or signal strength values for adjacent and/or nearby data bins. Value(s) for an empty bin can be based on signal quality values and/or signal strength values in adjacent and/or nearby data bins in the same radial direction as the empty data bin and/or based on signal quality values and/or signal strength values in adjacent and/or nearby data bins that are the same radial distance from the antenna as the empty data bin. The interpolation of the gaps in the MR data in the above embodiments can be performed as described above in the RSRP interpolation section.

In some embodiments, the performance of the first cell is to be assessed and the cell measurement data determined in step 1810 for the first cell is input to a trained ML model. The ML model has been trained to evaluate a performance of a cell based on input cell measurement data, and the ML model provides an output indicating the performance of the first cell. The performance of the first cell can be expressed using one or more metrics or parameters, relating to, for example, any of orientation, coverage distance and quality (interference). In some embodiments, the performance of the cell is indicated by one or more of an antenna orientation issue class, a cell coverage distance issue class, and a quality/interference issue class.

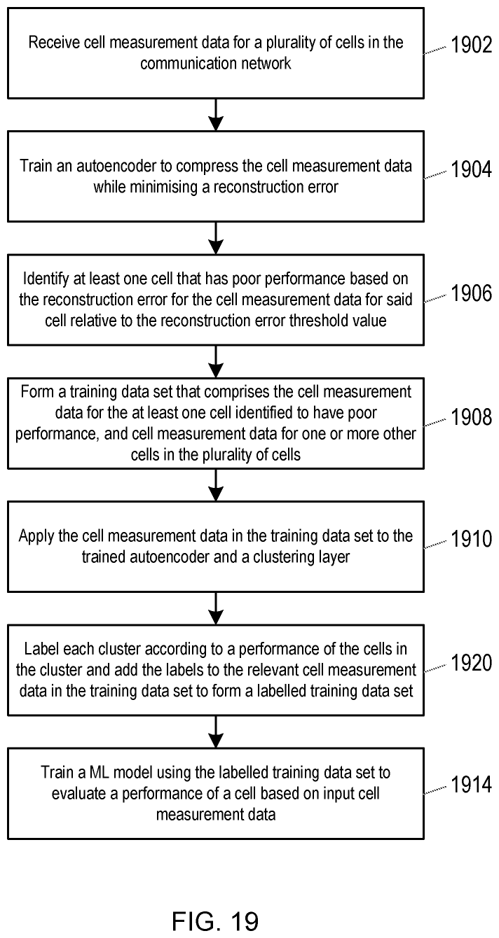

The flow chart in FIG. 19 illustrates a method of training a ML model for estimating the performance of a cell in a communication network according to various embodiments described herein. The method can be performed by any suitably configured computer or processor, for example in response to executing computer-readable code embodied or otherwise stored on a computer-readable medium. In some embodiments, the method in FIG. 19 can be performed by the apparatus 200 in FIG. 2 or the virtualization environment 300 in FIG. 3.

In step 1902 cell measurement data is received for a plurality of cells in the communication network. In some embodiments, the cell measurement data was prepared according to the method described above with respect to FIG. 18.

In step 1904, an autoencoder is trained to compress the cell measurement data while minimising a reconstruction error.

In step 1906, at least one cell is identified that has poor performance based on the reconstruction error for the cell measurement data. In particular, a cell with poor performance can be identified based on a comparison of the reconstruction error for the cell relative to a reconstruction error threshold value.

In step 1908, a training data set is formed that comprises the cell measurement data for the at least one cell identified to have poor performance, and cell measurement data for one or more other cells in the plurality of cells. These ‘other cells’ are cells which were not identified as having poor performance in step 1906.

In step 1910 the cell measurement data in the training data set is applied to the trained autoencoder and a clustering layer. The clustering layer receives an encoded representation of the cell measurement data from an encoding stage of the autoencoder, and the clustering layer clusters the encoded representations of the cell measurement data to minimise a clustering loss.

In step 1912, each cluster is labelled according to a performance of the cells in the cluster, and the labels are added to the relevant cell measurement data in the training data set to form a labelled training data set. In some embodiments, steps 1904, 1906, 1908, 1910 and 1912 can be performed as described above in the Anomaly Selection and Clustering sections and shown in FIGS. 14 and 15.

Finally, in step 1914 a ML model is trained, using the labelled training data set, to evaluate a performance of a cell based on input cell measurement data. The performance of the first cell can be expressed using one or more metrics or parameters, relating to, for example, any of orientation, coverage distance and quality (interference). In some embodiments, the performance of the cell is indicated by one or more of an antenna orientation issue class, a cell coverage distance issue class, and a quality/interference issue class. Step 1914 can performed as described above in the Model Training section.

In some embodiments, the ML model is a deep learning CNN model. In particular embodiments, the ML model is a skip-connect deep learning CNN model.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the scope of the disclosure. Various exemplary embodiments can be used together with one another, as well as interchangeably therewith, as should be understood by those having ordinary skill in the art.

1. A computer-implemented method of preparing cell measurement data for use with a machine learning, ML, model, the method comprising:
(a) receiving a plurality of measurement reports for a first cell in a communication network, each measurement report comprising a measurement of signal quality of signals in the first cell by a device, a measurement of signal strength in the first cell by the device, and a geolocation measurement indicating a geolocation of the device when the signal quality measurement and signal strength measurement were obtained;
(b) obtaining cell information for the first cell, the cell information comprising a geolocation of an antenna of a base station that provides the first cell and an azimuth angle indicating a direction of the antenna;
(c) for each measurement report, forming a converted measurement report by using the geolocation of the antenna and the azimuth angle to convert the geolocation of the measurement report to a polar coordinate system with the antenna as an origin of the polar coordinate system and the direction of the antenna as a polar angle reference direction;
(d) assigning each converted measurement report to a data bin according to polar coordinates of the converted measurement report, each data bin corresponds corresponding to a respective annular sector of a coverage area of the first cell; and
(e) generating cell measurement data for the first cell, the cell measurement data comprising a respective signal quality value and signal strength value for each data bin.

2. The method as claimed in claim 1, wherein one or more of: (i) the signal quality value is an aggregate signal quality measurement generated from the signal quality measurements in the converted measurement reports assigned to the respective data bin; (ii) the signal strength value is an aggregate signal strength measurement generated from the signal strength measurements in the converted measurement reports assigned to the respective data bin, and (iii) the cell measurement data further comprises a density value for each data bin representing a number of converted measurement reports assigned to the respective data bin relative to a number of converted measurement reports assigned to other data bins.

3. The method as claimed in claim 1, wherein a total area of the data bins is based on an expected coverage area of the first cell.

4. The method as claimed in claim 3, wherein the expected coverage area of the first cell is determined from an antenna height of the antenna in the obtained cell information, an antenna tilt angle in the obtained cell information and geolocations of one or more antennas of base stations that provide neighbouring cells to the first cell.

5. The method as claimed in claim 1, wherein each cell in the communication network has a same number of data bins.

6. The method as claimed in claim 1, wherein an area covered by respective data bins increases with increasing distance from the antenna.

7. (canceled)

8. The method as claimed in claim 1, wherein step (e) further comprises:
estimating data samples for one or more empty data bins from one or both signal quality values and signal strength values for one or both adjacent and nearby data bins.

9. The method as claimed in claim 8, wherein the estimating is based on one or both of:
one or both of signal quality values and signal strength values for one or both adjacent and nearby data bins in a same radial direction as the empty data bin; and
one or both of signal quality values and signal strength values in one or both adjacent and nearby data bins that have the same radial distance from the antenna as the empty data bin.

10. The method as claimed in claim 1, wherein the method further comprises:
(f) inputting the cell measurement data for the first cell to a ML model that has been trained to evaluate a performance of a cell based on input cell measurement data; and
(g) receiving an output from the trained ML model indicating the performance of the first cell.

11. A computer-implemented method of training a machine learning, ML, model to evaluate a performance of a cell in a communication network, the method comprising:
receiving cell measurement data for a plurality of cells in the communication network;
training an autoencoder to compress the cell measurement data while minimising a reconstruction error;
identifying at least one cell that has poor performance based on the reconstruction error for the cell measurement data for the cell relative to a reconstruction error threshold value;
forming a training data set that comprises the cell measurement data for the at least one cell identified to have poor performance, and cell measurement data for one or more other cells in the plurality of cells;
applying the cell measurement data in the training data set to the trained autoencoder and a clustering layer, the clustering layer receiving an encoded representation of the cell measurement data from an encoding stage of the autoencoder, and the clustering layer clustering the encoded representations of the cell measurement data to minimise a clustering loss;
labelling each cluster according to a performance of the cells in the cluster and adding the labels to the relevant cell measurement data in the training data set to form a labelled training data set;
training a ML model using the labelled training data set, the ML model being trained to evaluate a performance of a cell based on input cell measurement data.

12. The method as claimed in claim 11, wherein the performance of the cell is indicated by one or more of an antenna orientation issue class, a cell coverage distance issue class, and a quality/interference issue class.

13. The method as claimed in claim 11, wherein the ML model is a deep learning convolutional neural network, CNN, model.

14. (canceled)

15. The method as claimed in claim 11, wherein the received cell measurement data is prepared according to a preparing method for a plurality of cells, the preparing method comprising:
(a) receiving a plurality of measurement reports for a first cell in a communication network, each measurement report comprising a measurement of signal quality of signals in the first cell by a device, a measurement of signal strength in the first cell by the device, and a geolocation measurement indicating a geolocation of the device when the signal quality measurement and signal strength measurement were obtained;
(b) obtaining cell information for the first cell, the cell information comprising a geolocation of an antenna of a base station that provides the first cell and an azimuth angle indicating a direction of the antenna;
(c) for each measurement report, forming a converted measurement report by using the geolocation of the antenna and the azimuth angle to convert the geolocation of the measurement report to a polar coordinate system with the antenna as an origin of the polar coordinate system and the direction of the antenna as a polar angle reference direction;
(d) assigning each converted measurement report to a data bin according to polar coordinates of the converted measurement report, each data bin corresponds corresponding to a respective annular sector of a coverage area of the first cell; and
(e) generating cell measurement data for the first cell, the cell measurement data comprising a respective signal quality value and signal strength value for each data bin.

16-30. (canceled)

31. An apparatus for preparing cell measurement data for use with a machine learning, ML, model, the apparatus comprising a processor and a memory, the memory containing instructions executable by the processor to configure the apparatus to:
(a) receive a plurality of measurement reports for a first cell in a communication network, each measurement report comprising a measurement of signal quality of signals in the first cell by a device, a measurement of signal strength in the first cell by the device, and a geolocation measurement indicating a geolocation of the device when the signal quality measurement and signal strength measurement were obtained;
(b) obtain cell information for the first cell, the cell information comprising a geolocation of an antenna of a base station that provides the first cell and an azimuth angle indicating a direction of the antenna;
(c) for each measurement report, form a converted measurement report by using the geolocation of the antenna and azimuth angle to convert the geolocation of the measurement report to a polar coordinate system with the antenna as an origin of the polar coordinate system and the direction of the antenna as a polar angle reference direction;
(d) assign each converted measurement report to a data bin according to polar coordinates of the converted measurement report, each data bin corresponding to a respective annular sector of a coverage area of the first cell; and
(e) generate cell measurement data for the first cell, the cell measurement data comprising a respective signal quality value and signal strength value for each data bin.

32-40. (canceled)

41. An apparatus for training a machine learning, ML, model to evaluate a performance of a cell in a communication network, the apparatus comprising a processor and a memory, the memory containing instructions executable by the processor to configure the apparatus to:
receive cell measurement data for a plurality of cells in the communication network;
train an autoencoder to compress the cell measurement data while minimising a reconstruction error;
identify at least one cell that has poor performance based on the reconstruction error for the cell measurement data for the cell relative to a reconstruction error threshold value;
form a training data set that comprises the cell measurement data for the at least one cell identified to have poor performance, and cell measurement data for one or more other cells in the plurality of cells;
apply the cell measurement data in the training data set to the trained autoencoder and a clustering layer, the clustering layer receiving an encoded representation of the cell measurement data from an encoding stage of the autoencoder, and the clustering layer clustering the encoded representations of the cell measurement data to minimise a clustering loss;
label each cluster according to a performance of the cells in the cluster and adding the labels to the relevant cell measurement data in the training data set to form a labelled training data set; and
train a ML model using the labelled training data set, wherein the ML model is trained to evaluate a performance of a cell based on input cell measurement data.

42-46. (canceled)

47. The method as claimed in claim 2, wherein a total area of the data bins is based on an expected coverage area of the first cell.

48. The method as claimed in claim 47, wherein the expected coverage area of the first cell is determined from an antenna height of the antenna in the obtained cell information, an antenna tilt angle in the obtained cell information and geolocations of one or more antennas of base stations that provide neighbouring cells to the first cell.

49. The method as claimed in claim 2, wherein each cell in the communication network has a same number of data bins.

50. The method as claimed in claim 2, wherein an area covered by respective data bins increases with increasing distance from the antenna.

51. The method as claimed in claim 2, wherein step (e) further comprises:
estimating data samples for one or more empty data bins from one or both signal quality values and signal strength values for one or both adjacent and nearby data bins.
